(19) United States
(12) Patent Application Publication
(10) Pub. No.: US 2025/0310369 A1
(43) Pub. Date: Oct. 2, 2025

(54) THREAT ANALYSIS AND RISK ASSESSMENT SYSTEM

(71) Applicant: Volvo Car Corporation, Gothenburg (SE)

(72) Inventors: Xuan Guo, Gothenburg (SE); Haipeng Hu, Shanghai (CN); Shujuan Chen, Lund (SE)

(21) Appl. No.: 18/647,977

(22) Filed: Apr. 26, 2024

Related U.S. Application Data
(60) Provisional application No. 63/571,275, filed on Mar. 28, 2024.

(51) Int. Cl. H04L 9/40

(52) U.S. Cl. CPC H04L 63/1433

(57) ABSTRACT

Various systems and methods are presented regarding a threat analysis and risk assessment (TARA) system for implementation during design of a device, such as a software-defined vehicle. The system can be implemented across a manufacturing organization and combines knowledge from a range of entities, e.g., software programmers, hardware designers, network designers, and suchlike. Items and assets can be utilized to define respective features of components, e.g., defining software functionality, electronic control unit (ECU) configuration, a communication network connecting one or more ECUs and various signal inputs/outputs, etc. By representing components/features as items and assets, knowledge regarding potential/actual threats (e.g., cybersecurity attack(s)) can be respectively applied, damage scenarios and mitigation identified, threat risks assessed and reduced, with the whole system iteratively updated in response to newly derived configurations and knowledge regarding component of interest. Respective entities can apply their knowledge to supplement knowledge across the system, enabling interaction from multiple sources.

### CROSS-REFERENCE TO RELATED APPLICATIONS

This application claims priority to U.S. Provisional Patent Application Ser. No. 63/571,275, filed on Mar. 28, 2024, and entitled “THREAT ANALYSIS AND RISK ASSESSMENT SYSTEM”, the entirety of which is incorporated herein by reference.

### TECHNICAL FIELD

This application relates to cybersecurity of a vehicle, identifying and addressing threats and risks to the vehicle's security.

### BACKGROUND

Computer systems and networks are susceptible to cyber-attacks, whereby a cybercriminal conducts an attack to maliciously affect operation of processors, networks, and suchlike, and also seizing/destroying data. Incorporation of computer systems and other onboard systems, sensing, architecture into vehicles renders the vehicles susceptible to cyber-attacks. As vehicle manufacturers integrate computer systems, e.g., to develop software-defined vehicles, exposure to cyber-attacks, and the potential for damage, is increased.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to facilitate threat analysis and risk assessment (TARA) of a system during the development, manufacturing, and implementation lifecycle of the system. The system facilitates knowledge generated across a manufacturing entity to be pooled at a central resource, and TARA being applied to the centralized knowledge.

According to one or more embodiments, a system can comprise a memory that stores computer executable components and a processor that executes the computer executable components stored in the memory. The computer executable components can comprise a threat analysis and risk assessment (TARA) tool configured to determine a change in a first operating condition of an asset, wherein the asset represents an operational condition of an item, the change in operating condition results from a cyber-attack on the asset, and the change in operating condition generates a second operating condition of the asset, further identify a first damage scenario pertaining to the second operating condition of the asset, and further, assess a result of the first damage scenario on operational condition of the item based on the second operating condition of the asset.

In an embodiment, the change in operating condition of the asset from a first operating condition to a second operating condition can represent a change in operating condition of the asset in response to a simulation of the cyber-attack on the asset.

In an embodiment, the item can be located on a vehicle, wherein the vehicle can be a software-defined vehicle. In an embodiment, the item can be one of a software application, an electronic control unit (ECU), or a network device.

In a further embodiment, the asset can be a software function implemented on the ECU.

In an embodiment, the TARA tool can be further configured to determine a first damage impact level for the first damage scenario, wherein the first damage impact level indicates a first magnitude of damage resulting from the second operating condition of the asset implemented on the item. In a further embodiment, the TARA tool can be further configured to determine whether a magnitude of the first damage impact level is acceptable, and in response to a determination that the magnitude of the first damage impact level is unacceptable, implement a third operating condition at the asset. In a further embodiment, the TARA tool can be further configured to determine a second magnitude of a second damage impact level resulting from the third operating condition, and in response to a determination that second damage impact level is acceptable, implementing the third operating condition on the item to mitigate an effect of the cyber-attack.

In another embodiment, the system is a centralized system, and is further configured to receive information from at least one of a product design database, an entity, a development team, or an organizational metamodel, and the information relates to the asset implemented a design of a computer system located on a vehicle.

In a further embodiment, the first damage scenario can comprise: (a) a damage injured party attribute identifying an entity affected by the first damage scenario; (b) a damage category attribute identifying a negative effect of the first damage scenario; or (c) a damage condition attribute identifying a state when the first damage scenario occurred.

In other embodiments, elements described in connection with the disclosed systems can be embodied in different forms such as computer-implemented methods, computer program products, or other forms. For example, in an embodiment, a computer-implemented method can be performed by a device operatively coupled to a processor, the method comprising identifying, by the device, an operational condition of an asset resulting from a cyber-attack implemented on the asset, wherein the asset represents a functionality of an item; further determining, by the device, whether the operational condition of the asset deleteriously impacts operation of the item, and further, in response to a determination that the operation of the item is deleteriously impacted by the cyber-attack, indicating, by the device, that the asset is susceptible to the cyber-attack.

In an embodiment, the item can be included in a computer system implemented on a software-defined vehicle. In a further embodiment, the item can be one of a function type item, a hardware type item, or a network type item, wherein a function type item indicates the item is a software application, the hardware type item indicates the item is an electronic control unit (ECU), and the network type item indicates the item is one of a network device or network infrastructure.

In an embodiment, the asset can be a function type asset configured to be implemented on the hardware type item.

In an embodiment, the device is located at a centralized system, and at least one of the asset or the item are retrieved from a product design database communicatively coupled to the centralized system.

Further embodiments can include a computer program product comprising a computer readable storage medium having program instructions embodied therewith to enable TARA analysis of a system. The program instructions are executable by a processor located at a TARA system, and can cause the processor to perform operations, comprising: (a) identifying an operational condition of an asset resulting from a cyber-attack implemented on the asset, wherein the asset represents a functionality of an item; (b) determining whether the operational condition of the asset deleteriously impacts operation of the item; (c) and in response to a determination that the operation of the item is deleteriously impacted by the cyber-attack, indicating the asset is susceptible to the cyber-attack.

In an embodiment, the item can be included in a computer system implemented on a software defined vehicle.

In an embodiment, the operations can further comprise determining a configuration of the asset, wherein the configuration is resistant to the cyber-attack, further modifying the asset in accordance with the determined configuration, and further implementing the modified asset on the item to mitigate an impact of the cyber-attack. In an embodiment, modification of the asset can comprise recoding a software application, reconfiguring an electronic control unit, or reconfiguring a network architecture.

An advantage of the one or more systems, computer-implemented methods and/or computer program products can be pooling knowledge at a centralized TARA system, whereby the pooled knowledge enables accurate risk assessments to be performed owing to the knowledge being centrally compiled and collaborative interaction between respective entities involved in the design process, where, with a conventional approach, interaction between the respective entities would be limited/non-existent. For example, per the various embodiments presented herein, first information can be provided to the TARA system by a first entity designing/configuring an ECU platform in conjunction with second information regarding functionality to be implemented on the ECU platform. Hence, assessment of the risk of combining the ECU platform with the functionality is enhanced over the risk measure available from a conventional approach. Further, the various embodiments utilize assets of an item to assess the risk, providing a granular assessment unavailable when utilizing only the items.

### DESCRIPTION OF THE DRAWINGS

One or more embodiments are described below in the Detailed Description section with reference to the following drawings.

FIG. 1A presents a system configured to be implemented in a TARA operation to combine threats to software, hardware, and network architecture to enable understanding of an effect and attack path of potential cyber-attacks, and creation of a mitigation strategy in response to the identified threats (both actual and potential), in accordance with at least one embodiment.

FIG. 1B presents a system configured to be implemented in a TARA operation to combine threats to software, hardware, and network architecture to enable understanding of an effect and attack path of potential cyber-attacks, and creation of a mitigation strategy in response to the identified threats (both actual and potential), in accordance with at least one embodiment.

FIG. 2 presents a schematic of a common information model for a software-defined vehicle on-board system, in accordance with an embodiment.

FIG. 3 presents a flow diagram for a computer-implemented method, providing a high-level overview of the TARA process, per the various embodiments presented herein.

FIGS. 4A-C combine to present a schematic illustrating various operations/processes/activities regarding an iterative product design and deployment operation for one or more TARA operations, in accordance with an embodiment.

FIG. 4D-F, present schematics regarding interaction of at least items, assets, threats, damages, and risks, in accordance with an embodiment.

FIG. 5 presents a schematic illustrating a threat scenario and the respective impacts on ‘rating’, in accordance with an embodiment.

FIG. 6A illustrates a method of cyber-attack, in accordance with an embodiment.

FIG. 6B illustrates respective entities interacting with respective components and knowledge update/sharing, in accordance with an embodiment.

FIG. 7 illustrates a trunk attack path, in accordance with an embodiment.

FIG. 8 illustrates an attack model for a branch attack path, in accordance with an embodiment.

FIG. 9 presents a schematic illustrating respective attack steps and threat scenarios on an ECU asset, in accordance with an embodiment.

FIG. 10 presents a flow diagram for a computer-implemented method, providing a high-level overview of the TARA process, per the various embodiments presented herein.

FIG. 11 presents a flow diagram for a computer-implemented method, providing a high-level overview of the TARA process, per the various embodiments presented herein.

FIG. 12 presents a flow diagram for a computer-implemented method, providing a high-level overview of the TARA process, per the various embodiments presented herein.

FIG. 13 presents a flow diagram for a computer-implemented method, providing a high-level overview of the TARA process, per the various embodiments presented herein.

FIG. 14 is a block diagram illustrating an example computing environment in which the various embodiments described herein can be implemented.

FIG. 15 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, the Detailed Description section, and the Abstract.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer.

### Abbreviations

The following abbreviations are used herein:
CAL: Cybersecurity Assurance Level
CVE: Common Vulnerabilities and Exposures
DoIP: Diagnostic communication over Internet Protocol
ECU: Electronic Control Unit
E/E: Electrical and Electronic
IDPS: Intrusion Detection and Prevention System
OBD: On-Board Diagnostic
OEM: Original Equipment Manufacturer
PSIRT: Product Security Incident Response Team
TARA: Threat Analysis and Risk Assessment

### Terms/Definitions

The followings terms and definitions are used here:
Asset: an object, property, computer object/property of an item, against which a cyberattack can be implemented.
Attack path, Attack vector, Attack Surface: one or more actions that can be combined to realize a threat scenario.
Component: part that is logically and technically separable, e.g., hardware component/device/equipment, software component/program/application, network system, and suchlike.
Continuous Integration/Continuous Delivery (CI/CD): refers to the concept of integration, testing, and delivery of software code changes/iterations, e.g., updating operational software of a vehicle.
Cybersecurity concept: cybersecurity requirements of an item, one or more assets, and/or requirement(s) on the operational environment/operation of a vehicle, with associated information on cybersecurity controls.
Cybersecurity control: a process or measure that can be implemented against an actual/potential threat to modify a risk of the actual/potential threat occurring.
Ecosystem: the environment in which the system/vehicle is predicted to operate. During operation, as well as operations being performed onboard the vehicle/system, the system/vehicle can also interact with an off-board, remotely-located system, e.g., cloud-based system, a software application implemented on a mobile device (e.g., mobile phone, a cellphone, a laptop, internet of things, etc.), and suchlike. The ecosystem of operation provides knowledge regarding threats and sources of those threats.
ECU: Electronic Control Unit, configured to control operation of one or more systems located/installed/implemented on the system. In an aspect, an ECU can be implemented on a vehicle, with an ECU being an embedded system in automotive electronics configured to control one or more electrical systems or subsystems onboard the vehicle. The terms ECU and hardware/device are used interchangeably and denote a computer/processor configured to host/implement one or more software functions, where respective ECUs can be communicatively coupled via an onboard network, with information/data being transferred between the respective ECUs via the onboard network.
Function: one or more high level operations/functionality/service provided by a vehicle to an operator of the vehicle, as well as low level functionality provided by one or more devices/equipment located onboard the vehicle facilitating the high level operations.
Item: component or set of components that implements a function at the vehicle level.
Software-Defined Vehicle: refers to a vehicle having capabilities that are defined by a software system operating on the vehicle, whereby capabilities of the vehicle can be configured/expanded based on updates to the software operating on the vehicle.
Threat scenario: potential cause/activity involved in compromising one or more properties of one or more assets. Identifying one or more threat scenarios enables one or more damage scenarios to be derived/determined/identified.
ISO/SAE 21434: Specification regarding cybersecurity for vehicles, automotives, etc. However, the various embodiments presented herein can be directed towards any suitable/applicable specification/regulation pertaining to operation of a vehicle or system to susceptible to threats (e.g., cybersecurity threats) deleteriously affecting operation of the vehicle/system.

### A. Technical Background and Implementation of a Tara System

Conventionally, TARA can be complicated to implement owing to such issues as:
(a) TARA predictions/results are naturally subjective regarding the type of threat that can occur and associated damage resulting therefrom, wherein the TARA prediction can depend heavily on the knowledge and experience of an entity (e.g., a threat analyzer) evaluating the threat, damage, etc.
(b) cybersecurity experts having sufficient TARA competence may not be available/rare in a given organization.
(c) a vehicle having complicated, onboard systems/system solutions may be designed/developed by numerous development teams located across an organization/manufacturing process. The systems/solutions may be developed/implemented in an iterative fashion, with the respective development team largely operating in an isolated fashion. For example, hardware/ECU team(s) work separately from the network/communication team(s), and further separately from the software/functionality team(s). This can be particularly relevant to a software-defined vehicle, which requires smooth and efficient CI/CD development and implementation across the respective onboard systems/functionality. Accordingly, with a conventional approach, a TARA process can be hard to configure/implement/perform, particularly where a TARA process is required to perform analysis that is accurate and consistent (e.g., with regard to the mentioned operational scenarios above, and the use case scenarios below).
(d) successful implementation and use of a TARA process can require extensive traceability of components, devices, systems, functionality, networks, communications, and suchlike, for long-term maintenance and development of a vehicle (e.g., a software-defined vehicle), wherein the traceability can extend for 15 years or more.

Per the various embodiments presented herein, TARA methods and processes are presented to enable, accurate and efficient implementation of a TARA system. The following, while non-limiting, present various use cases for the various embodiments presented herein:
(i) Iterative product design/development, particularly for design/development of a software-defined vehicle(s). Simultaneously achieve iterative updating of the TARA process following each cycle of product design/development review/implementation in combination with enabling CI/CD.
(ii) PSIRT team can perform effective and efficient TARA when any of a new attack tactic, attack technique, or system vulnerability 606A-n, is identified, with one or more mitigating activities being undertaken to mitigate risk as soon as the risk has been identified. The TARA process can be applied at any phase of a system lifecycle, from design through to post-production.
(iii) The TARA process can be implemented at the initial stages of threat penetration test analysis.
(iv) The various embodiments presented herein are amenable to implementing an autonomous TARA system and/or an autonomous IDPS.
(v) The various embodiments presented herein disclose a TARA process that can adapt to iterative development of a vehicle, e.g., a software-defined vehicle.
(vi) Per the various embodiments presented herein, a TARA system can function as a centralized system configured to compile and analyze data, information, etc., from across the multitude of development teams and departments involved in designing and developing a system such as a vehicle.

### B. High-Level Overview of Tara System for Iterative Product Design and Development

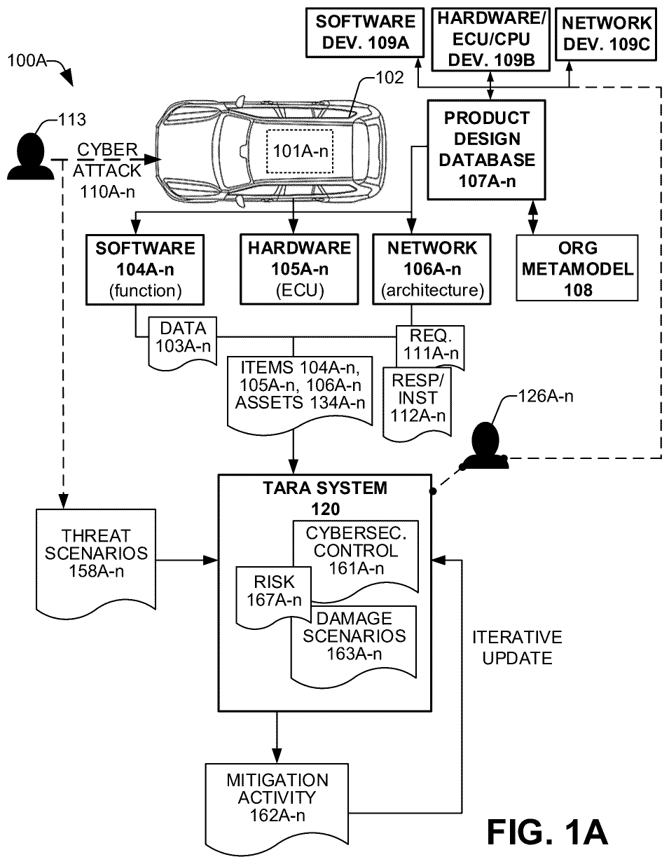

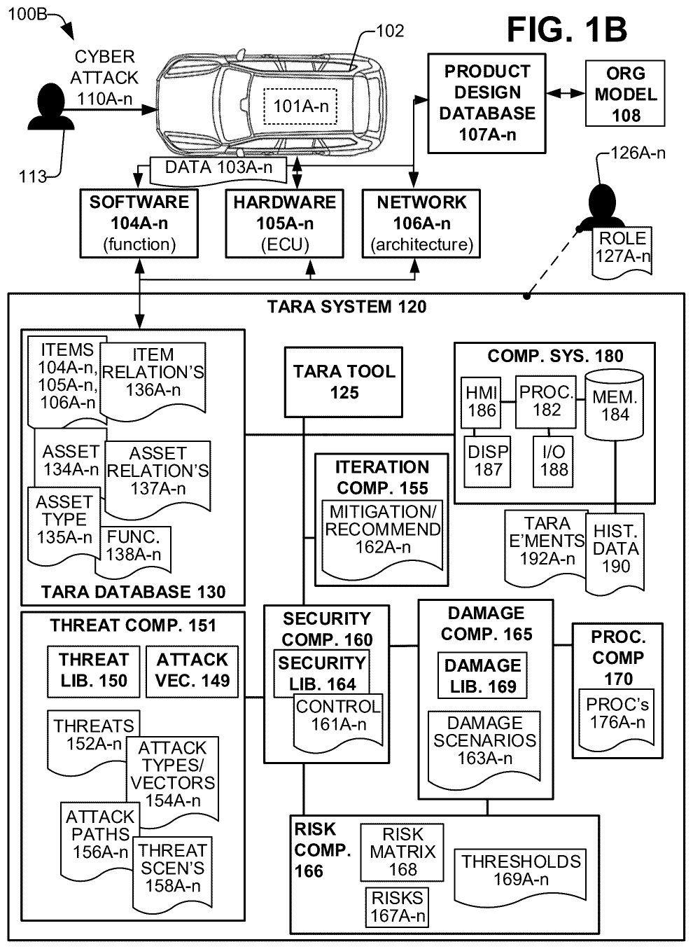

FIG. 1A, system 100A, presents a high level overview of a TARA system configured to identify, assess, mitigate, and/or prevent a cyber-attack directed towards equipment, in accordance with one or more embodiments. In the example scenario presented, the equipment is a vehicle.

As shown, a vehicle 102 can be designed to have a computer-based system 101A-n implemented thereon, e.g., where the system 101A-n enables respective functions/functionality to be available at the vehicle 102. For example, computer-based system 101A-n enables operation of vehicle 102 to be classified as a software-defined vehicle. System 101A-n can be an entirety of a computer system provided onboard vehicle 102 (e.g., comprising multiple ECUs, network components, software functions), or one or more sub-systems (e.g., navigation, infotainment, battery control, etc., comprising a limited number of ECUs, a limited network, limited software functionality, and suchlike).

System 101A-n can be configured to include/comprise respective devices/hardware 105A-n (e.g., ECUs), software 104A-n implemented/operating thereon (e.g., a software application, software program), and communications across network architecture 106A-n. In an embodiment, respective software 104A-n can be configured to control operation of respective devices included in hardware 105A-n. In an embodiment, vehicle 102 can be configured and operate as a software-defined vehicle, wherein a software-defined vehicle describes a vehicle whose features, capabilities, functions, and suchlike are enabled through software, with new features/functions being available via updates/upgrades to the software 104A-n, and ECUs 105A-n/networks 106A-n as required to implement the updated/upgraded software 104A-n.

As further shown, the various embodiments can be implemented to simulate, emulate, etc., a cyber-attack 110A-n being conducted by a malicious entity 113 against on one or more elements of vehicle 102, e.g., against respective instances of the software 104A-n, against a hardware device 105A-n, a combination of both software 104A-n and hardware 105A-n, across network 106A-n. Per the various embodiments presented herein, based on analysis of the software 104A-n, hardware 105A-n, and/or network 106A-n, one or more actual or potential cyber-attacks 110A-n can be determined for the software 104A-n, hardware 105A-n, and/or network 106A-n, and further simulated as part of a TARA process (e.g., TARA process 410, as further described).

In an embodiment, to identify/monitor/prevent such cyber-attack 110A-n, operation of vehicle 102 can be simulated/modeled by a TARA system 120, wherein the TARA system 120 can be a system located/operating/accessible at a manufacturing facility at which the vehicle 102 is manufactured. TARA system 120 can be centralized system and also a remotely-located, cloud-based system. In another embodiment, the TARA system 120 can be implemented onboard vehicle 102.

During the initial stages of the TARA process, respective software 104A-n, devices 105A-n (with software 104A-n implemented thereon), and networking of the devices 105A-n across a network 106A-n, implemented on vehicle 102, can be identified. In an embodiment, respective entities 126A-n involved in any of the design stage, manufacturing stage, operational testing, post-production stage, etc., can interact with the TARA system 120 to enable respective knowledge, system data, test data, operational data, customer feedback, etc., to be compiled (e.g., as historical data 190 in memory 184, as further described). TARA system 120 can be a centralized system receiving data and information from respective departments/teams (e.g., software development 109A, hardware/ECU/CPU development 109B, network development 109C, entities 126A-n, and suchlike), e.g., via the product design database 107A-n, in accord with the organization metamodel 108, and suchlike.

Software 104A-n, hardware 105A-n, and/or network 106A-n, can be respectively represented/referenced as respective item/items: software item 104A-n, hardware item 105A-n, and/or network item 106A-n. As further shown, a software item 104A-n can be directed towards issues/aspects regarding function/functionality provided by/implemented by a software application/software program, a hardware item 105A-n can be directed towards issues/aspects regarding operation and structure of ECUs/devices/hardware, and a network item 106A-n can be directed towards issues/aspects regarding architecture/communications/infrastructure.

Information/knowledge regarding any of software 104A-n, hardware 105A-n, and/or network 106A-n, can be provided by any of entities 126A-n, identified/retrieved from product design database 107A-n, identified/retrieved from the organizational metamodel 108, generated/identified by one or more artificial intelligence and/or machine learning processes (e.g., processes 176A-n implemented by process component 170, as further described), and suchlike. The terms hardware item(s) and ECU item(s) are used interchangeably herein. Accordingly, a physical device such as an ECU is considered herein to be both a device and an item, and similarly a defined network is considered herein to be both a device and an item, and the functionality provided by execution of a software application on the ECU is referenced with the software providing the functionality.

Each of the items 104A-n, 105A-n, and 106A-n, can have assigned thereto/be expressed by one or more assets 134A-n (e.g., a property, a computer object such as a variable, a data structure, a function, a method, etc.). In an embodiment, assets 134A-n can be utilized to represent one or more properties/attributes 135A-n such as category, type, status, location, and suchlike, as further described. In an embodiment, one or more items 104A-n, 105A-n, 106A-n, assets 134A-n, etc., can be provided to a TARA system 120 (e.g., by an entity 126A-n, by product design database 107A-n, etc.). In another embodiment, one or more components included in TARA system 120 can be configured to automatically identify the one or more items 104A-n, 105A-n, 106A-n, assets 134A-n, etc., as further described.

Items 104A-n, 105A-n, 106A-n, and assets 134A-n can have associated/pertinent data/information 103A-n (e.g., a property, function, configuration, attribute, feature, and suchlike). The term data 103A-n is being used herein to convey both data/knowledge regarding an item 104A-n/105A-n/106A-n and also data/information being conveyed over a network/infrastructure 106A-n between respective ECUs/hardware 105A-n, e.g., as generated by software 104A-n executing on an ECU/hardware 105A-n.

As further shown, a prospective cyber-attack 110A-n can be represented, simulated, etc., as a threat scenario 158A-n. In an embodiment, respective threat scenarios 158A-n can be provided to the TARA system 120 (e.g., via entity 126A-n, product design database 107A-n, and suchlike). In another embodiment, the one or more threat scenarios 158A-n can be automatically identified, generated, determined, inferred, etc., by one or more components included in TARA system 120, as further described. In an embodiment, respective threat scenarios 158A-n can be determined for respective assets 134A-n (and associated items 104A-n, 105A-n, 106A-n). For example, a first threat scenario 158A can be identified at the TARA system 120 as a first prospective attack 110A against a first asset 134A, while a second threat scenario 158B can be identified as a second prospective attack 110B against a second asset 134B, wherein the first asset 134A and second asset 134B can be defined for the same or disparate items 104A-n, 105A-n, and/or 106A-n.

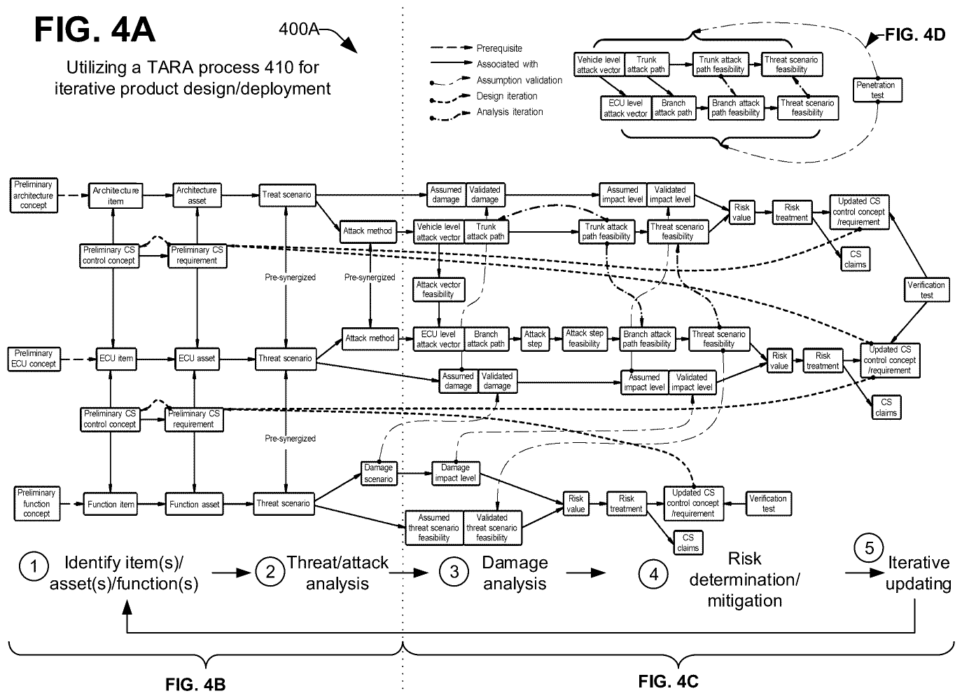

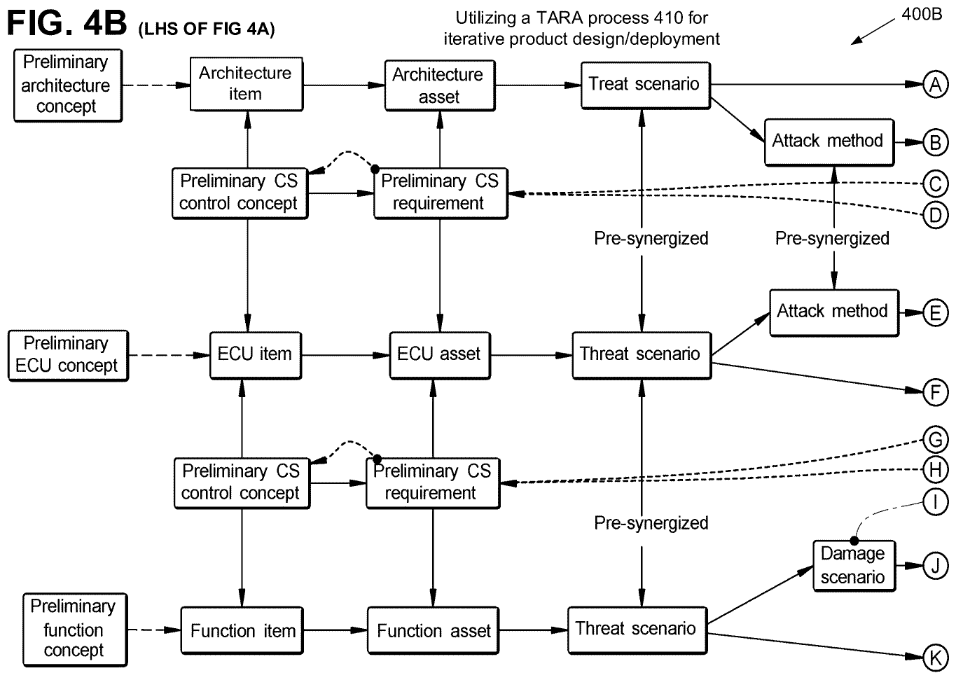

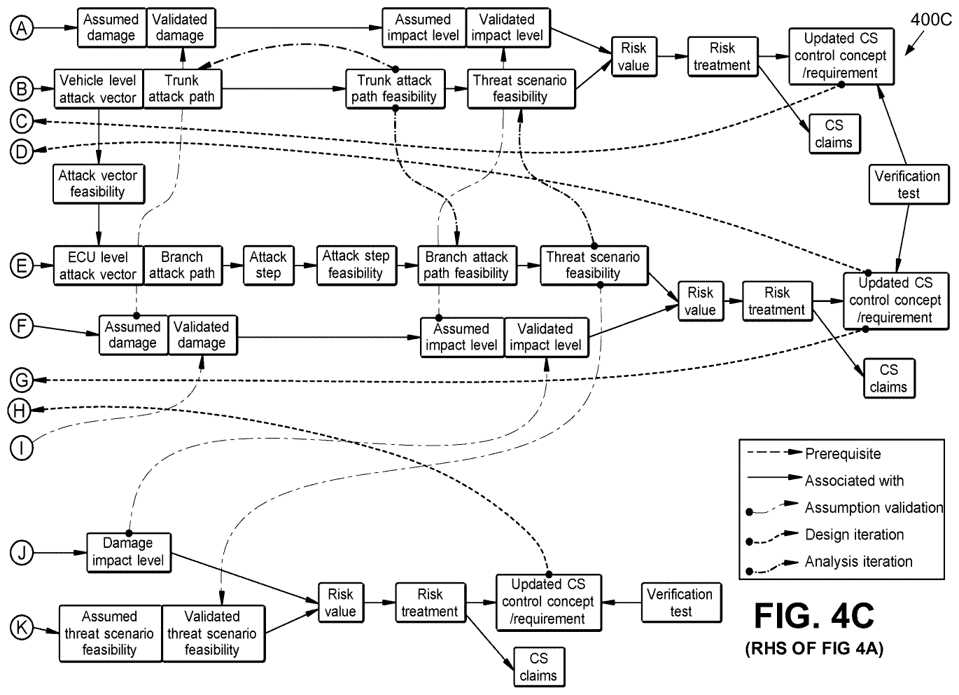

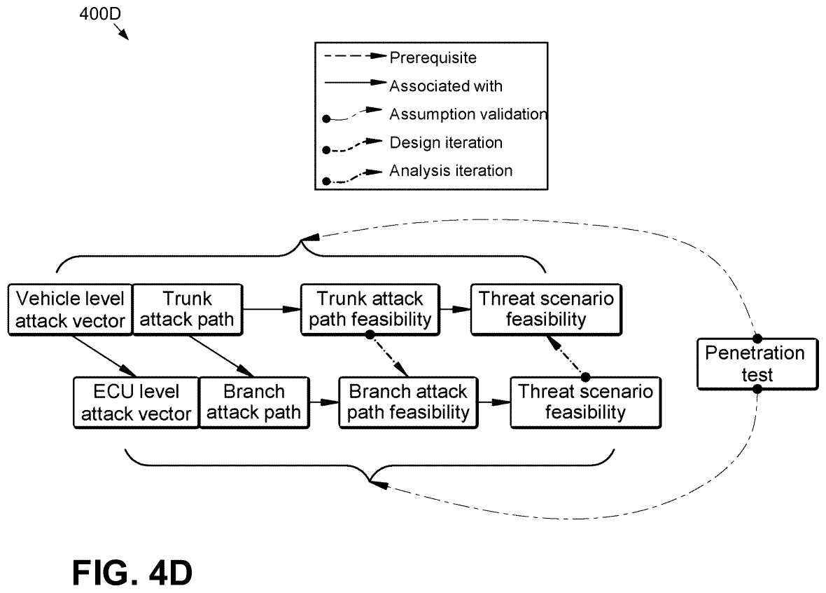

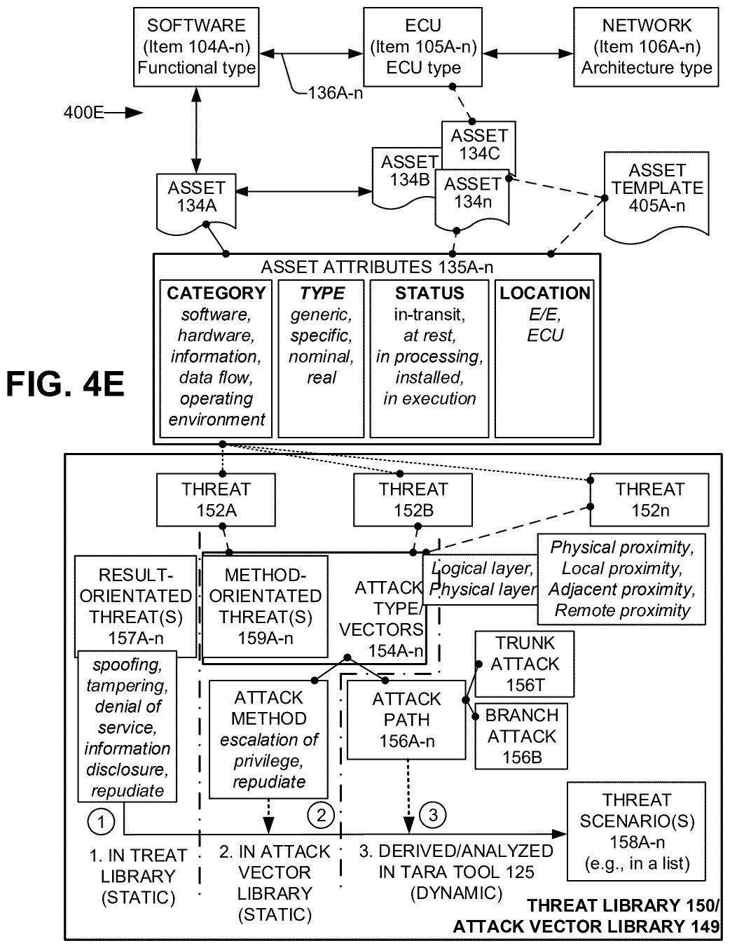

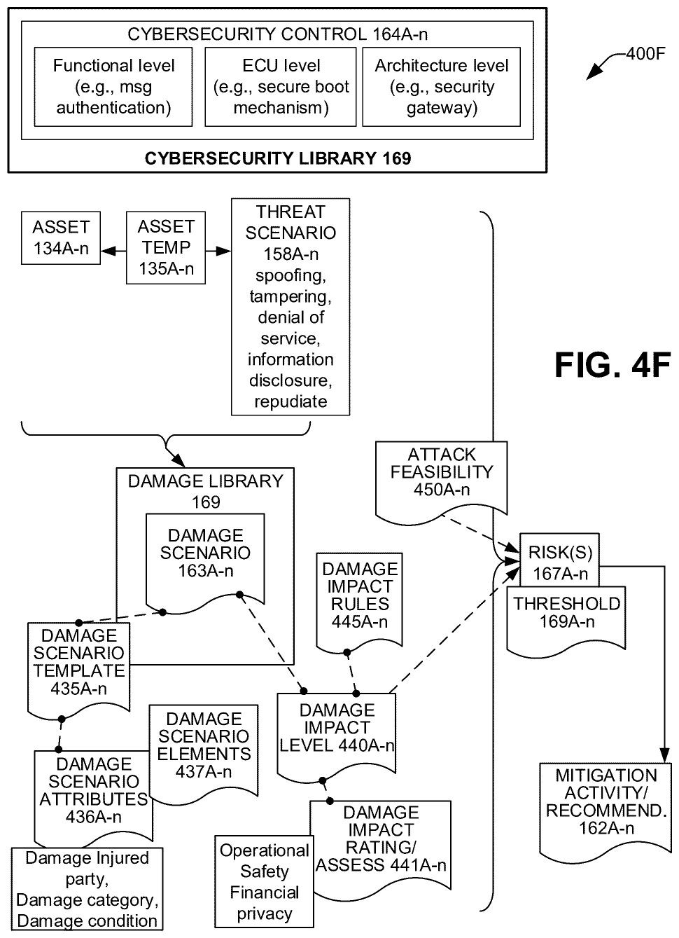

In conjunction with respective threat scenarios 158A-n being defined, one or more cybersecurity controls 161A-n can also be defined, wherein the one or more cybersecurity controls 161A-n can represent a method, process, technique, and suchlike, configured to be implemented to prevent/mitigate an occurrence of a threat scenario 158A-n. In a further embodiment, damage scenarios 163A-n can also be defined for respective threat scenarios 158A-n occurring at an asset 134A-n (and associated items 104A-n, 105A-n, 106A-n). From the respective threat scenario 158A-n, a likelihood of the threat scenario 158A-n being successfully implemented (aka attack feasibility rating 450A-n, per FIG. 4F), and the corresponding damage scenario 163A-n (aka impact rating 441A-n), a risk 167A-n can be determined and compared with threshold values 172A-n in a risk matrix table 168 (as further described). Accordingly, in the event of a first threat scenario 158M having a high feasibility 450A of occurrence in combination with a high level of deleterious impact 441A (e.g., first damage scenario 163A is rated as severe risk), attention towards mitigating the first threat scenario 158M (e.g., with a first mitigation activity 162N) can be prioritized over a second threat scenario 158N having a low feasibility 450B of occurrence in combination with a low level of deleterious impact 441B (e.g., second damage scenario 163B is rated as negligible risk). In an embodiment, a mitigation activity 162A-n can be based on a currently available cybersecurity control 161A-n which has been updated/improved in view of the assessment of risk 167A-n and knowledge regarding how to mitigate the threat scenario 158A-n.

With one or more mitigation activities/processes 162A-n, etc., implemented to reduce the first threat scenario 158M from a high level to a moderate/low/acceptable level of deleterious/negative impact, the respective assets 134A-n, and items 104A-n, 105A-n, and 106A-n, etc., can be updated (e.g., replaced, redesigned, reconfigured, reprogrammed, and suchlike) in view of the effect of the implemented mitigating activity 162M on the subsequent operation of vehicle 102 in response to a subsequent cyber-attack 110A-n.

FIG. 1B, system 100B further presents an overview of a TARA system configured to identify, mitigate, and/or prevent a cyber-attack directed towards a piece of equipment, wherein the equipment can be a vehicle, in accordance with one or more embodiments.

As shown, a vehicle 102 can have operating thereon, respective software 104A-n, devices/hardware 105A-n, and network 106A-n. As shown, a malicious entity 113 can be committing/intending to commit a cyber-attack 110A-n against any of the software 104A-n, hardware device(s) 105A-n, across network 106A-n. Per the various embodiments presented herein, one or more cyber-attacks 110A-n can be determined, simulated, etc., as part of a TARA process 410.

TARA system 120 can include a TARA tool 125. As further described in sections 1-13 below, TARA tool 125 can be configured to implement (e.g., automatically) respective TARA processes and methods to identify, mitigate, simulate and/or prevent an actual or simulated cyber-attack 110A-n that can be implemented against a vehicle 102, software 104A-n, hardware 105A-n, and/or network 106A-n.

As mentioned and as further described, one or more features, functions, and suchlike, of software 104A-n, hardware 105A-n, and/or network 106A-n can be identified as items 104A-n, 105A-n, and/or 106A-n. Furthermore, one or more item relationships 136A-n between software item(s) 104A-n, hardware item(s) 105A-n, and/or network item(s) 106A-n, can also be defined. An item relationship 136A-n can connect a first item with a second item, enabling connection/interrelatedness of items 104A-n/105A-n, 106A-n to be defined, such that the impact of an attack directed towards a first item can be assessed at an interrelated nth item. Items 104A-n, 105A-n, and/or 106A-n and item relationships 136A-n can be compiled/stored in a TARA database 130 (which can be further stored in memory 184, and/or uploaded to product design database 107A-n), and accessed by TARA tool 125.

Associated with each item 104A-n, 105A-n, and/or 106A-n is an asset 134A-n (further compiled/stored in TARA database 130), as further described. An asset 134A-n can represent an object/property/function of an item 104A-n/105A-n/106A-n, against which a cyberattack 110A-n can be implemented. Furthermore, one or more asset relationships 137A-n between two or more assets 134A-n, can also be defined. An asset relationship 137A-n can connect a first asset with a second asset, enabling connection/interrelatedness of assets 134A-n (and items 104A-n/105A-n, 106A-n) to be defined, such that the impact of an attack directed towards a first asset can be assessed at an interrelated nth item. Assets 134A-n and asset relationships 137A-n can be compiled/stored in a TARA database 130 (which can be further stored in memory 184, and/or uploaded to product design database 107A-n), and accessed by TARA tool 125.

In an embodiment, the respective items 104A-n, 105A-n, 106A-n, and/or assets 134A-n can be provided to TARA system 120 as part of a configuration of system 101A-n being designed by entities 126A-n, departments 109A-n. In another embodiment, the respective items 104A-n, 105A-n, 106A-n, and/or assets 134A-n can be automatically identified by the TARA system 120. For example, TARA tool 125 can be configured to automatically identify/retrieve one or more items 104A-n, 105A-n, and/or 106A-n, one or more assets 134A-n pertaining to one or more of the items 104A-n, 105A-n, and/or 106A-n.

As further described, one or more threat scenarios 158A-n can be identified for items 104A-n, 105A-n, and/or 106A-n and/or assets 134A-n. Threat scenarios 158A-n can be defined/generated from respective identified/defined threats 152A-n and/or attack types/vectors 154A-n. The respective threats 152A-n and attack types/vectors 154A-n can have respective identified/defined attack paths 156A-n, as further described. Threat scenarios 158A-n, threats 152A-n, attack types/vectors 154A-n, and attack paths 156A-n, can be compiled and stored in a threat library 150 (e.g., in memory 184), wherein information, data, etc., in threat library 150 can be compiled/generated by threat component 151/TARA tool 125. Threat component 151 and threat library 150 are communicatively coupled to and accessible by TARA tool 125. In an embodiment, as further described, threat scenarios 158A-n can also be assigned/utilized to determine a threat rating/risk 167A-n. Threat component 151, TARA tool 125, and suchlike, can be configured to automatically identify/generate one or more threat scenarios 158A-n for the respective items 104A-n, 105A-n, and/or 106A-n and/or assets 134A-n, e.g., as currently determined or in historical data 190.

Further, a security component 160 (e.g., a cybersecurity component) can be communicatively coupled to TARA tool 125 and threat component 151. Security component 160 can be configured with a set of various cybersecurity controls 161A-n, wherein the cybersecurity controls 161A-n can be utilized by the security component 160 to potentially mitigate an effect of a threat scenario 158A-n (reactive), and/or preventing a threat scenario 158A-n from being implemented in the first place (proactive). In an aspect, the security component 160 can be associated with the threat scenarios 158A-n defined/generated from respective threats 152A-n, attack types/vectors 154A-n, attack paths 156A-n, and cybersecurity controls 161A-n.

Security component 160, TARA tool 125, and suchlike, can be configured to automatically identify/generate one or more cybersecurity controls 161A-n for any of the respective items 104A-n, 105A-n, and/or 106A-n, assets 134A-n, and/or threat scenarios 158A-n, e.g., as currently determined or in historical data 190.

TARA system 120 can further include a damage component 165 comprising damage scenarios 163A-n, wherein the damage scenarios 163A-n can identify/define respective damage results/damage impacts of the respective threat scenarios 158A-n in one or more cyber-attacks 110A-n that can be employed/simulated against vehicle 102. Damage component 165, TARA tool 125, and suchlike, can be configured to automatically identify/generate one or more damage scenarios 163A-n for any of the respective items 104A-n, 105A-n, and/or 106A-n, assets 134A-n, threat scenarios 158A-n, and/or damage scenarios 163A-n, e.g., as currently determined or in historical data 190.

TARA system 120/TARA tool 125 can further include a risk component 166 configured to determine a risk 167A-n of a threat scenario 158A-n occurring. In an embodiment, a risk 167A-n can be automatically generated based on a correlation of two factors, attack feasibility 450A-n (e.g., threat scenario 158A-n occurring) and damage impact level 441A-n (e.g., in damage scenarios 163A-n). With reference to TABLE 4, below, in an embodiment, security component 160 can be configured to determine an attack feasibility 450A-n and the damage component 165 can be configured to determine the impact level 441A-n of an attack. In an embodiment, risk 167A-n can be determined in accordance with ISO 21434, e.g., a risk 167A-n of 1 is a negligible/very low level of risk, while a risk 167A-n of 5 is a severe/high level of risk. The risk component 166 can be configured to automatically determine the risk 167A-n, e.g., from TABLE 4, and further, based on comparison of risk 167A-n and a threshold value 172A-n, the risk component 166 can be further configured to determine whether a magnitude of attack 110A-n is of such concern that the respective aspects (e.g., any of items 104A-n, 105A-n, 106A-n, assets 134A-n, threat scenario 158A-n, damage scenario 163A-n, and suchlike) require attention/modification or the magnitude of the attack 110A-n is of a low level, that other attacks 110A-n are to be prioritized.

In an embodiment, risk component 166 can be configured to rank any of a series of risks 167A-n/attacks 110A-n/threat scenarios 158A-n, damage scenarios 163A-n, etc., in order of severity (e.g., highest risk to lowest risk 167A-n, acceptable risk versus unacceptable risk) to enable the respective threat scenarios 158A-n/attacks 110A-n to be addressed and thereby increase the security of system 101A-n to attacks 110A-n.

TARA system 120 can further include an iteration component. Iteration component 155 can further include one or more mitigation activities 162A-n, wherein the mitigation strategies 162A-n can be developed subsequent to a risk value 167A-n being generated and evaluated (as further described).

As one or more risks 167A-n/threat scenarios 158A-n/attacks 110A-n are addressed, respective mitigation strategies 162A-n can be implemented (e.g., by iteration component 155) with one or more components/devices in system 101A-n (e.g., configurations of items 104A-n, 105A-n, and/or 106A-n, assets 134A-n) modified/updated/replaced in accordance with the mitigation strategies/recommendations 162A-n.

Iteration component 155 can update system 101A-n, items 104A-n, 105A-n, 106A-n, assets 134A-n iteratively, such that an initial mitigation strategy 162A-n/assessment can be subsequently applied to current knowledge across TARA system 120, e.g., in a feedback manner, e.g., to update existing/prior cybersecurity controls 161A-n. In performing the reduction in risk, the TARA system 120 can be updated with the respective changes/adjustments implemented (e.g., per recommendation(s) in mitigation activity 162A-n), e.g., to determine if the change(s) was successful and further determine if the change implemented with regard to a first item 104A, 105A, or 106A and/or asset 134A affected a security risk 167B at a second item 104B, or 105B, or 106B and/or asset 134B.

In an aspect, items 104A-n/105A-n/106A-n, and/or assets 134A-n can be utilized to describe the scope of the TARA process 410, and form the foundation for the various activities performed across the TARA process 410. As further described in Section 2, items 104A-n, 105A-n, and 106A-n can be utilized to define respective components, etc., across the system 101A-n, e.g., architecture, ECU, function, and suchlike. By utilizing items 104A-n, 105A-n, and 106A-n, various functionalities can be identified/defined, e.g., regarding a coding attack on a software 104A-n, as well as the environment in which the software 104A-n functions, e.g., software 104A is configured to operate within the environment of an ECU 105A located on-board/configured to be located onboard vehicle 102. Information regarding items 104A-n, 105A-n, 106A-n, and/or assets 134A-n, can be stored and retrieved (e.g., via an API) from a product design database 107A-n.

Further, respective knowledge regarding the items 104A-n, 105A-n, 106A-n, and/or assets 134A-n, can be employed at TARA system 120 as a function of the respective knowledge of an entity 126A-n concerned with TARA of vehicle 102. For example, a first entity 126A can be a software programmer/developer responsible for designing and implementing software 104A. Further, a second entity 126B can be a component designer/engineer responsible for designed and implementing devices 105A-n for use on vehicle 102. A third entity 126C can be a network engineer designing the communication architecture to be implemented onboard vehicle 102. Accordingly, the use of items 104A-n, 105A-n, 106A-n and associated assets 134A-n and attributes 135A-n/functions 138A-n (e.g., relating to operation of one or more assets 134A-n) enables the TARA tool 125 to combine the knowledge available from first entity 126A, second entity 126B, and third entity 126C, (e.g., in combination with processes 176A-n) and to further identify the respective threats scenarios 158A-n, damage scenarios 163A-n, risks 167A-n, and mitigation strategy 162A-n.

As further shown, a process component 170 can be communicatively coupled to TARA tool 125, wherein process component 170 can be configured to utilize one or more artificial intelligence (AI) and/or machine learning (ML) processes 176A-n to assist in identification/determination/inference/implementation/processing of any of the respective parameters, components, and suchlike, grouped under the collection of terms/items/assets, etc., in TARA elements 192A-n, wherein the term TARA elements 192A-n includes any of (and as further described), in a non-limiting list: items 104A-n, 105A-n, 106A-n, data/information 103A-n, item relationships 136A-n, assets 134A-n, asset attributes 135A-n, asset relationships 137A-n, functions 138A-n, threat scenario 158A-n (e.g., including threats 152A-n, attack type/vector 154A-n, attack paths 156A-n, result-orientated threats 157A-n, method-orientated threats 159A-n, trunk attack path 156A-n, branch attack path 156A-n, vehicle level attack vector 154A-n, ECU level attack vector 154A-n, attack method, attack step), damage scenarios 163A-n (e.g., including product damage scenario, user damage scenario, organizational damage scenario, damage scenario attributes 436A-n, damage impact level 440A-n, damage impact rating/assessment factor 441A-n, damage impact rules 445A-n), attack step feasibility 450A-n, asset template 405A-n, threat scenario feasibility 450A-n, impact level, risk value 167A-n, risk treatment, cybersecurity control concept 161A-n, cybersecurity requirement, cybersecurity claim, verification test, penetration test, mitigation strategy/activity/recommendation 162A-n, risks 167A-n, thresholds 172A-n, cyber-attacks 110A-n, content of historical data 190A-n, software 104A-n, hardware 105A-n, network 106A-n, similarity indexes S1-n, vectors Vn, and suchlike.

In an embodiment, the TARA system 120 can be updated in an iterative manner (e.g., by iteration component 155), such that as respective associations 136A-n/137A-n are established between items 104A-n, 105A-n, and/or 106A-n, and assets 134A-n, threat scenarios 158A-n are subsequently determined for the assets 134A-n, and further damage scenarios 163A-n defined for the instances of software 104A-n, hardware 105A-n, and/or network 106A-n, the knowledge gained can be used to train the processes 176A-n and further update any of the TARA elements 192A-n. Accordingly, during an initial implementation/iteration, TARA knowledge of the software 104A-n, hardware 105A-n, network 106A-n, item relationships 136A-n, threats 152A-n, attack types/vectors 154A-n, attack paths 156A-n, threat scenarios 158A-n, damage scenarios 163A-n, etc., may be limited to the knowledge provided by entities 126A-n and/or available from the product design database 107A-n. In an embodiment, the respective mitigation strategies 162A-n can also function as recommendations, whereby as a mitigation strategy 162A-n is determined/generated, the mitigation strategy 162A-n can be forwarded to the product design database 107A-n to update respective information/data 103A-n stored at the product design database 107A-n (e.g., for further access by any of software development team 109A-n, hardware design team 109B, network development team 109C, one or more entities 126A-n, and suchlike), as well as incorporation into information/data comprising items 104A-n, 105A-n, 106A-n, assets 134A-n, historical data 190, elements 192A-n, and suchlike.

As the series of iterations of TARA process 410 are implemented by iteration component 155, the respective knowledge gained from each iteration can be fed back into the TARA system 120 (e.g., processes 176A-n are further trained with newly available knowledge/information 103A-n), enabling more extensive, knowledgeable associations to be made between any of TARA elements 192A-n, such as software 104A-n, hardware 105A-n, network 106A-n, assets 134A-n, and the respective threats 152A-n that can be employed in conjunction with the attack vectors 154A-n, attack paths 156A-n, threat scenarios 158A-n, potential damage scenarios 163A-n, risks 167A-n, mitigations/recommendations 162A-n, other TARA elements 192A-n, and suchlike. Furthermore the respective knowledge gained from each iteration of the TARA system 120 can be utilized in current/future product design (e.g., of software 104A-n, hardware 105A-n, network 106A-n), e.g., where products can be designed, modified, improved, replaced, etc., to reduce the risk 167A-n of a threat scenario 158A-n, threat 152A-n, attack vector 154A-n, attack paths 156A-n, e.g., to strengthen design of vehicle 102 against cyber-attack 110A-n, e.g., per mitigations/recommendations 162A-n.

As mentioned, TARA tool 125 can be communicatively coupled to product design database 107A-n (e.g., via an API) to facilitate iterative product design and development. Accordingly, as mitigation strategies 162A-n are determined, respective elements, data, information, etc., stored in the product design database 107A-n can be updated to reflect one or more effects of implementing the respective mitigation strategies 162A-n. Hence, as the TARA process 410 is iteratively performed, recommendations 162A-n can be generated by TARA tool 125/iteration component 155 regarding improved design, implementation, etc., of software functionality 104A-n, hardware/devices/ECUs 105A-n, network/system infrastructure 106A-n, to mitigate risk 167A-n/damage scenarios 163A-n of susceptibility to cyberattack 110A-n/threat scenarios 158A-n.

As further shown, TARA system 120 can be communicatively coupled to/include a computer system 180. Computer system 180 can include a memory 184 that stores the respective computer executable components (e.g., TARA tool 125, threat component 151, iteration component 155, security component 160, damage component 165, risk component 166, process component 170, and suchlike, as further described herein) and further, a processor 182 configured to execute the computer executable components stored in the memory 184. Memory 184 can further be configured to include TARA database 130, threat library 150, security library 164, damage library 169, risk matrix 168, TARA elements 192A-n, items 104A-n, 105A-n, 106A-n, data/information 103A-n, item relationships 136A-n, assets 134A-n, asset attributes 135A-n, asset relationships 137A-n, functions 138A-n, threat scenario 158A-n (e.g., including threats 152A-n, attack type/vector 154A-n, attack paths 156A-n, result-orientated threats 157A-n, method-orientated threats 159A-n, trunk attack path 156A-n, branch attack path 156A-n, vehicle level attack vector 154A-n, ECU level attack vector 154A-n, attack method, attack step), damage scenarios 163A-n (e.g., including product damage scenario, user damage scenario, organizational damage scenario, damage scenario attributes 436A-n, damage impact level 440A-n, damage impact rating/assessment factor 441A-n, damage impact rules 445A-n), attack step feasibility 450A-n, asset template 405A-n, threat scenario feasibility 450A-n, impact level, risk value 167A-n, risk treatment, cybersecurity control concept 161A-n, cybersecurity requirement, cybersecurity claim, verification test, penetration test, mitigation strategy/activity/recommendation 162A-n, risks 167A-n, thresholds 172A-n, cyber-attacks 110A-n, content of historical data 190A-n, software 104A-n, hardware 105A-n, network 106A-n, similarity indexes S1-n, vectors Vn, and suchlike, and further, historical data 190, wherein historical data 190 can include any previously/current/future defined/identified/processed TARA elements 192A-n, items 104A-n, 105A-n, and/or 106A-n, assets 134A-n, item relationships 136A-n, functions 138A-n, threats 152A-n, attack type/vectors 154A-n, attack paths 156A-n, damage scenarios 163A-n, mitigation strategies 162A-n, software 104A-n, hardware 105A-n, cyber-attacks 110A-n, and suchlike.

The computer system 180 can further include a human machine interface (HMI) 186 (e.g., a display, a graphical-user interface (GUI)) which can be configured to present various information regarding any of the TARA elements 192A-n, per the various embodiments presented herein. HMI 186 can include an interactive display/screen 187 to present the various data/information 103A-n, relationships, recommendations, etc. Computer system 180 can further include an I/O component 188 to receive and/or transmit respectively newly defined (e.g., as entered by entity 126A-n, determined by one or more of TARA tool 125, threat component 151, security component 160, damage component 165, risk component 166, process component 170/processes 176A-n, iteration component 155, and suchlike) information regarding any of the TARA elements 192A-n, and suchlike. Any suitable technology can be utilized for interaction/communication by I/O 188, e.g., file transfer protocol (FTP), simple radio standalone (SRS), and suchlike.

As mentioned, TARA system 120 can include a process component 170 and processes 176A-n. It is to be appreciated that processes 176A-n can comprise any AI/ML model/technology/technique/architecture utilized to automatically define/generate/identify any of TARA elements 192A-n, historical data 190, and further automatically develop mitigation strategies 162A-n, etc., and further enhance TARA system 120. Process component 170 can be utilized to implement processes 176A-n in conjunction with any of the other components included in TARA system 120, e.g., TARA tool 125, security component 160, and suchlike.

It is to be appreciated that the various processes 176A-n and operations presented herein are simply examples of respective AI and ML operations and techniques, and any suitable technology can be utilized in accordance with the various embodiments presented herein. Processes 176A-n can be implemented on/trained on TARA elements 192A-n, and suchlike. In an example embodiment, processes 176A-n can include a vector component to apply any suitable vectoring technology, such as bag of words (BOW) text vectors, Euclidean distance, cosine similarity, etc. Other suitable AI/ML technologies that can be applied can include, in a non-limiting list, any of vector representation via term frequency-inverse document frequency (tf-idf) capturing term/token frequency in the respective prior/current/future TARA elements 192A-n and historical data 190, e.g., by neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, and suchlike. Accordingly, in an embodiment, implementation of TARA tool 125, threat component 151, iteration component 155, security component 160, damage component 165, risk component 166, and suchlike, with processes 176A-n, enables natural language processing (NLP) (e.g., utilizing vectors) to be implemented to generate and utilize the respective knowledge/development of the TARA system 120.

Language models, LSTMs, BARTs, etc., can be formed with a neural network that is highly complex, for example, comprising billions of weighted parameters. Training of the language models, etc., can be conducted, e.g., by process component 170, with datasets, whereby the datasets can be formed using any suitable technology, such as TARA elements 192A-n, information in historical data 190A-n, data/information 103A-n, and suchlike. The TARA elements 192A-n, historical data 190A-n, etc., can be available from many sources, e.g., prior implementation of TARA system 120, as well as provided by an entity 126A-n, and suchlike, to generate current/future TARA elements 192A-n.

Fine-tuning of a processes 176A-n can comprise application of a current/prior TARA elements 192A-n, historical data 190A-n, etc., and suchlike to the processes 176A-n, whereby a process 176A-n is correspondingly adjusted by application of the current/prior TARA elements 192A-n, historical data 190A-n, and suchlike, such that, for example, weightings in the process 176A-n are adjusted by application of the current/prior TARA elements 192A-n, historical data 190A-n, and suchlike.

During application of processes 176A-n, vector representations V1-n can be applied to any of prior and current current/prior TARA elements 192A-n, historical data 190A-n, such that vector similarity operations (e.g., vector clustering/distancing) can be applied to generate a future TARA element 192A-n from the accrued prior knowledge regarding generation and implementation of prior TARA elements 192A-n. The degree of similarity (e.g., via similarity indexes S1-n) between respective information can be determined, for example, based on a threshold reflecting a proximity of a first vector generated from information pertaining to a current TARA element 192C and a second vector generated from information pertaining to a prior TARA element 192P, enabling ranking of similarity, e.g., via vector quantization.

It is to be appreciated that TARA tool 125, threat component 151, iteration component 155, security component 160, damage component 165, risk component 166, process component 170, and suchlike, present in system 100A/100B can function as separate components/implemented independently, the respective components and functionality can be combined into a single component, such as TARA tool 125 operating as a single, high-level component, with one or more of threat component 151, iteration component 155, security component 160, damage component 165, risk component 166, process component 170, and suchlike, operating as a sub-component of TARA tool 125.

As previously mentioned, ISO/SAE 21434 specification defines what aspects are to be analyzed in a TARA process. TARA process 410, and various embodiments presented herein, are configured to function (e.g., to analyze/address a potential TARA situation) in accordance with ISO/SAE 21434.

The various embodiments presented herein provide a standardized approach to defining, analyzing, and evaluating a TARA situation, enabling improved objective and quantitative analysis compared to a conventional approach. The various embodiments presented herein also provide clear and logical ways to define the TARA elements, information flow, and implementation of a TARA procedure across respective stages of a TARA process.

In an embodiment, TARA tool 125 can be configured to logically allocate different TARA assignments to respective components located in the TARA system 120 as well as to different entities 126A-n, based on, for example, the TARA process itself, TARA elements 192A-n, historical data 190A-n, and one or more features involved in developing system 101A-n at software-defined vehicle 102. The various embodiments presented herein, enable synchronization among the respective components in TARA system 120 in conjunction with TARA system 120 providing centralized cybersecurity, and further in conjunction with entities 126A-n, development teams 109A-n, etc.

In an aspect, TARA tool 125 may be lacking sufficient information 103A-n to enable a determination of any of an item 104A-n/105A-n/106A-n, an asset 134A-n, a threat scenario 158A-n, a damage scenario 163A-n, a cybersecurity control 161A-n, a mitigation strategy 162A-n, a risk level 167A-n, a TARA element 192A-n, and suchlike, and accordingly, TARA tool 125 can generate a request 111A-n (e.g., via I/O system 188) for further information to be provided by any of entities 126A-n, development teams 109A-n, retrieved from product design database 107A-n, and suchlike. Knowledge at the TARA system 120 can be updated with information/data 103A-n provided in a response 112A-n, wherein the response 112A-n can be provided in response to a request 111A-n, or unprompted. In an embodiment, response 112A-n can comprise an operational instruction for one or more components located on TARA system 120. Accordingly, as the TARA process 410 iterates, knowledge/information/data at the TARA system 120 can be updated from, and accordingly shared with entities 126A-n, development teams 109A-n, etc. Further, based on the continually improving/expanding knowledge/data/information 103A-n, processes 176A-n can provide further recommendations, data-associations, etc., that are not available with a conventional TARA system.

In an embodiment, any of the threat scenarios 158A-n, the cybersecurity controls 161A-n, the damage scenarios 163A-n, the mitigation strategies 162A-n, and suchlike, can exist prior to a current iteration of the TARA process 410, e.g., any of the threat scenarios 158A-n, the cybersecurity controls 161A-n, the damage scenarios 163A-n, the mitigation strategies 162A-n, and suchlike, can be generated/determined in a prior iteration of the TARA process 410, e.g., by one or more of the components included in TARA system 120, by processes 176A-n, and suchlike, and are included in historical data 190A-n, etc. In an alternative embodiment, any of the threat scenarios 158A-n, the cybersecurity controls 161A-n, the damage scenarios 163A-n, the mitigation strategies 162A-n, and suchlike, can be generated in real-time, e.g., by any of the one or more of the components included in TARA system 120, by processes 176A-n, and suchlike, e.g., based on information/data 103A-n, respective information/features/functions regarding cyber-attacks 110A-n, items 104A-n/105A-n/106A-n, assets 134A-n, and suchlike.

It is to be appreciated that while the various embodiments presented herein are directed towards implementation on a software-defined vehicle, the various embodiments and concepts are not so limited, and can be equally applied to any environment/application utilizing computer-controlled operation of systems, devices, components, etc. For example, the various embodiments can be utilized in a health care environment (e.g., programming of MRI machines, patient data system, and suchlike), financial (e.g., programming of a banking system), transportation (e.g., programming of a shipping/logistics system), aeronautical (e.g., programming of flight instructions for an aircraft, programming of an air traffic control system), and suchlike.

### C. Common-Information Model for Software-Defined Vehicle Development

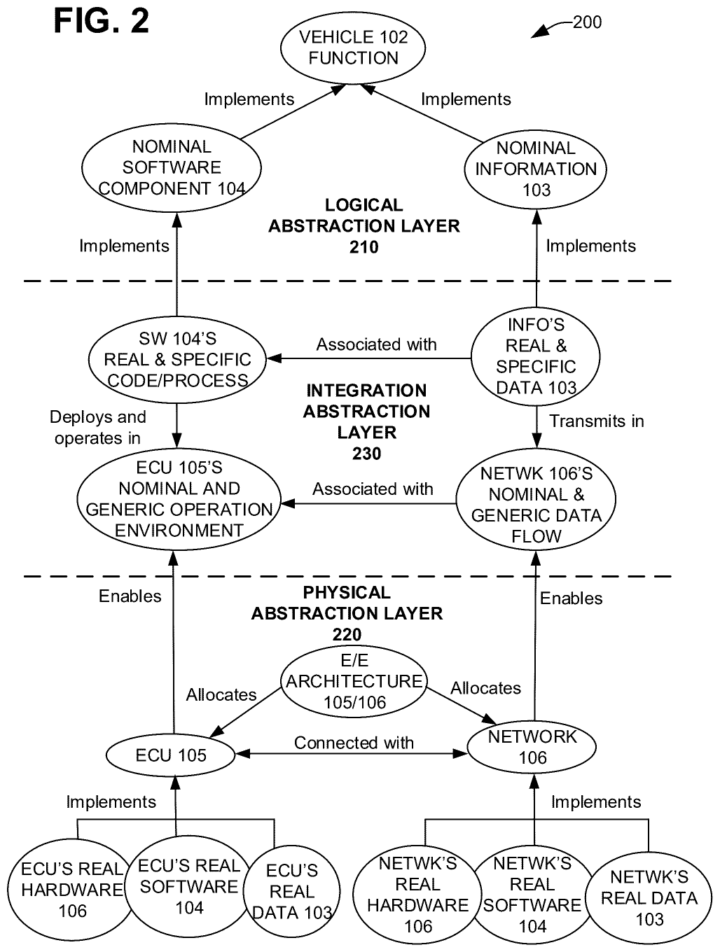

FIG. 2, schematic 200 illustrates a common information model of an on-board system, implemented, for example, on a software-defined vehicle, in accordance with an embodiment. Model 200 can be utilized by TARA system 120, as further described herein. The common information model 200 can comprise of three layers/categorizations: (i) a logical abstraction layer 210, (ii) a physical abstraction layer 220, and (iii) an integration abstraction layer 230, as further described.
(i) LOGICAL ABSTRACTION LAYER 210 can be utilized to assist in understanding the meaning of product functions and the logical relationship between various product functions. Various entities at the logical abstraction layer 210 can be skilled in analyzing damage scenario and impact assessment. For example, at the logical abstraction layer 210, review regarding implementation of one or more of the following can occur:
   (a) one or more product functions 104A-n implemented at the vehicle level,
   (b) information 103A-n flow between the respective product functions 104A-n, and
   (c) one or more software components 104A-n which can be implemented to achieve respective product functions.

In an embodiment, entities 126A-n (e.g., software developers, engineers, designers, and suchlike) involved with development and implementation of software 104A-n can apply their knowledge and understanding at the logical abstraction layer 210.
(ii) PHYSICAL ABSTRACTION LAYER 220 can function like a carrier by which entities of logical abstraction layer 210 can be implemented. At the physical abstraction layer 220, entities 126A-n can apply understanding, knowledge, hardware development and implementation, etc., regarding E/E architecture topology of vehicle 102, and further conduct analysis regarding attack path(s) 156A-n, attack feasibility 450A-n, and suchlike. For example, physical abstraction layer 220 can involve components/considerations such as:
   (a) physical network switch 106A-n, gateway, physical ECUs, and interfaces at vehicle 102, and
   (b) components/structure of an ECU 105A-n, such as ECU memory, ECU hardware, ECU firmware, and suchlike at vehicle 102.
(iii) INTEGRATION ABSTRACTION LAYER 230 comprises a system engineering layer to iteratively connect functionality of software items 104A-n involved with the logical abstraction layer 210 with the hardware items 105A-n/106A-n pertaining to the physical abstraction layer 220. Respective aspects of CI/CD are applicable at the integration abstraction layer 230. At the integration abstraction layer 230, the respective components (e.g., TARA tool 125, threat component 151, iteration component 155, security component 160, damage component 165, risk component 166, process component 170, and suchlike), and entities 126A-n can exchange/combine respective TARA knowledge/analysis and collaborate to iteratively develop a secured system solution for operation of vehicle 102, and the on-board software 104A-n, hardware 105A-n, and/or network 106A-n. To achieve an acceptable level of risk for both software 104A-n and hardware 105A-n (e.g., at the ECU), the software developer 126A and the hardware developer 126B can iteratively tune (e.g., in conjunction with knowledge/data/information 103A-n generated by TARA system 120) their respective designs to match the respective operational/security requirements, for example:
   (a) a specific process for a software 104A involves selecting a particular hardware 105A (e.g., an ECU) and further, an execution environment of the hardware 105A in which the software 104A is to operate, e.g., select an ECU's normal memory plus CPU, or select an ECU's Trusted Execution Environment with lower attack feasibilities.
   (b) storage of specific data 103A-n requires a particular storage environment at an ECU 105A-n, e.g., select between an ECU's normal SSD or an ECU's Hardware Security Module (HSM).
   c) specific data 103A-n requires a particular generic data flow to carry/transfer/transmit from a source to a destination across at network 106A, e.g., a SOME/IP data flowpath or a CAN data flowpath.

### D. Cybersecurity Activities

Regarding the various embodiments presented herein, two types of cybersecurity activities can relate to TARA process 410: (a) centralized activity and (b) distributed activity:
a) Centralized Cybersecurity Activity, can comprise:
   being performed by a centralized-type of team 126A-n, e.g., a vehicle architecture team, PSIRT team;
   initiated at an early phase of a vehicle 102 design/development project, wherein various product design assumptions can be made, and validate by one or more distributed activities;
   can be utilized to govern the distributed cybersecurity activities, thereby maintaining TARA consistency;
   analysis can be conducted at the vehicle 102 ecosystem level, e.g., responsible for the completeness of TARA; and/or
   amenable to overall attack path 156A-n analysis at architecture level of system 101A-n.
b) Distributed Cybersecurity Activity, can comprise:
   being performed by a distributed-type of team 126A-n, e.g., ECU team, product function team;
   based on the TARA result, iterate the system solution to implement logical layer functions by deploying the software component 104A-n to a certain environment of an ECU 105A-n;
   validating an assumption(s) from central cybersecurity activity, and responsible for the correctness of TARA; and/or
   feedback to central cybersecurity activity to achieve ecosystem level iteration.

The TARA methods and processes presented herein can be implemented over the whole life-cycle of vehicle 102, from concept phase to post-production phase. The TARA process 410 enables the connection to the PSIRT's work, such that the TARA process can be implemented whenever a new vulnerability 606A-n (e.g., to an attack 110A-n) is identified.

### E. Tara Process/Method for Iterative Product Design and Development

As further described in Sections 1-13 below, TARA system 120, TARA tool 125 and associated components can be configured to implement the respective TARA processes and methods.

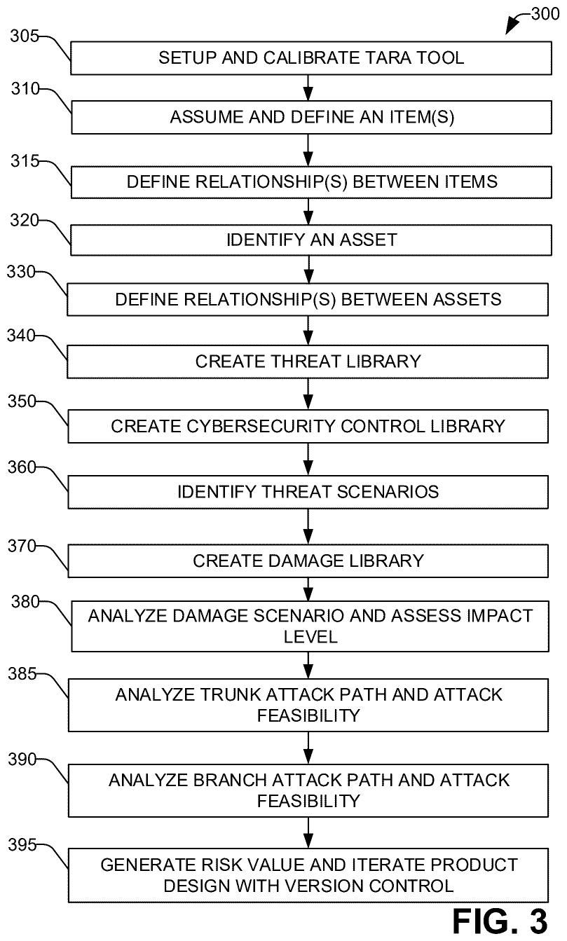

FIG. 3, process 300 presents a high-level overview of the TARA process, per the various embodiments presented herein. Each of the steps 305-395 are described further below, per respective Section 1-13. It is to be appreciated that while an entity 126A-n can perform an operation/process/action/activity, etc., the operation, process, etc., can be automatically performed by a respective component in TARA system 120, e.g., TARA tool 125, threat component 151, iteration component 155, security component 160, damage component 165, risk component 166, process component 170, and suchlike. In an embodiment, processes 176A-n can provide AI/ML to supplement operation of a respective component in TARA system 120, e.g., to facilitate automatic/autonomous operations and processes such as identification, retrieval, determination, and suchlike, of items 104A-n, 105A-n, 106A-n, assets 134A-n, threats 152A-n, attack vectors 154A-n, attack paths 156A-n, threat scenarios 158A-n, cybersecurity controls 161A-n, mitigation strategy 162A-n, damage scenarios 163A-n, risks 167A-n, a TARA element 192A-n, and suchlike.

Further, for the various operations, methods, etc., presented herein (e.g., in Sections 1-13, flowcharts 10-13, etc.) a TARA tool 125 can be configured to perform the respective operation, method, etc., either as a single component or in conjunction with any of threat component 151, security component 160, damage component 165, process component 170, an entity 126A-n, and suchlike. Hence, while a statement may be made “TARA tool 125 can be configured to . . . ”, it is to be appreciated that the respective operation, method, etc., can be performed by the TARA tool 125 operating in isolation or in conjunction with any of the components included in TARA system 120, an entity 126A-n, and/or one or more processes 176A-n.

### 1. Tara Tool Setup & Calibration (Step 305)

The TARA tool 125 can be configured to map respective TARA elements such as software item 104A-n, hardware/ECU item 105A-n, network/infrastructure 106A-n, and asset(s) 134A-n, to corresponding elements in an organization's metamodel 108. Accordingly, the TARA tool 125 can be configured to identify and retrieve respective data 103A-n of interest/content regarding system 101A-n from the product design database 107A-n to perform TARA processing and enable iterative vehicle 102 design/development based on the TARA result (e.g., wherein the result can be a risk 167A-n and associated information, such as threat scenarios 158A-n, damage scenarios 163A-n, damage mitigation activity 162A-n, and suchlike).

The TARA tool 125 can be further configured to assign different sensitivity levels and different security access controls to different entities/users 126A-n according to their role/type 127A-n. User roles 127A-n can include, in a non-limiting list:
Software engineer
Hardware engineer
TARA tool administrator
Architecture item/asset entity
ECU item/asset entity
Function item/asset entity
External supplier entity
PSIRT entity
Penetration testing entity

FIGS. 4A-D, TARA process models 400A-D, combine to present a schematic illustrating various operations/processes/activities regarding an iterative product design and deployment operation for one or more TARA operations, in accordance with an embodiment. For readability, TARA process 410 depicted in FIG. 4A is split into two portions, a left-hand portion (per FIG. 4B) and a right-hand portion (per FIGS. 4C & 4D). It is to be appreciated that for readability, a selection of aspects are labelled, however, from the respective terms and placement in the models 400A-D, the aspect of interest can be readily determined.

Reading FIG. 4A from left to right, FIG. 4A presents the respective operations comprising the TARA process 410, progressing through:
(1) identifying/assigning items 104A-n, 105A-n, and/or 106A-n, assets 134A-n, and functionality/properties;
(2) identifying/generating threat scenarios 158A-n (e.g., comprising threats 152A-n, attack types/vectors 154A-n, attack paths 156A-n) being identified;
(3) determining potential cybersecurity mitigation (e.g., cybersecurity controls 161A-n) and assessment of damage, e.g., potentially resulting from damage scenarios 163A-n;
(4) evaluating risks 167A-n and generating one or more mitigation strategies 162A-n; and
(5) subsequent iterative updating of the TARA process, items 104A-n, 105A-n, and/or 106A-n, assets 134A-n, and functionality/properties, TARA elements 192A-n, etc., based on the findings and outcomes of the previously mentioned operations.

For readability, FIGS. 4E and 4F, schematics 400E and 400F, present respective components, properties, etc., implemented with the various embodiments presented herein. As shown in FIG. 4E, the respective hardware, software, network(s), etc., potentially included in system 101A-n present on a vehicle 102 can be represented as items: software/software functionality item(s) 104A-n, hardware item(s) 105A-n, and network item(s) 106A-n. One or more relationships between respective items 104A-n, 105A-n, and/or 106A-n can be identified as relationships 136A-n (e.g., per Section 3).

Each of the items 104A-n, 105A-n, and 106A-n, can be respectively assigned (e.g., by TARA tool 125, provided by entity 126A-n) assets 134A-n, whereby an asset 134A-n can be further assigned/described with an asset category, an asset type, and asset status, and asset location (e.g., per Section 4). Asset relationships 137A-n can also be identified for two or more assets 134A-n, such that when a threat/attack is identified as being implemented against a first asset 134A, other assets 134B-n associated with/related to asset 134A can be identified to enable assessment of an effect of the threat/attack being further implemented against assets 134B-n, e.g., as an attack propagates across vehicle 102 (e.g., per section 5).

For each of the items 104A-n, 105A-n, and 106A-n and assets 134A-n, respective potential threat scenarios 158A-n can be defined (e.g., by threat component 151, provided by entity 126A-n), wherein a threat scenario 158A-n can be derived/determined based on a combination of knowledge regarding a threat 152A-n, an attack type/vector 154A-n, and/or an attack path 156A-n. Accordingly, a first threat 152A against a first asset 134A of an ECU item 105A via a first path 156A can generate a first threat scenario 158A compared with a first threat 152A against a second asset 134B of an ECU item 105A via a second path 156B can generate a second threat scenario 158B.

With the respective threat scenarios 158A-n determined, in conjunction with knowledge regarding respective items 104A-n, 105A-n, and 106A-n (e.g., assets 134A-n, functionality, etc.), one or more damage scenarios 163A-n can be identified/determined (e.g., by damage component 165, provided by entity 126A-n). In an attempt to pre-emptively prevent the damage scenarios 163A-n from being implemented, one or more cybersecurity controls 161A-n can be defined (e.g., by security component 160, by an entity 126A-n). Based on a respective attack scenario 158A-n, the item 104A-n, 105A-n, 106A-n, and associated assets 134A-n, ability to implement a security control 161A-n, assess damage scenario 163A-n, etc., a risk 167A-n can be determined and assessed based on threshold values 172A-n in a risk matrix 168.

As shown in FIG. 4E, threat library 150 can also include an attack vector library 149. In an embodiment, the threat scenarios 158A-n can be considered to be static/stable items (per region 1) and stored in/retrievable from the threat library 150. The threat scenario 158A-n is a results-oriented threat. A threat scenario 158A-n can be considered to be static/stable, functioning as an anchor to link/connect analysis between different type items. For example, a threat scenario 158A-n can be described as a ‘Disclosure of the data being processed in an ECU's execution environment, leads to a loss of confidentiality of the data’. A threat scenario 158A-n can be understandable and identified by both a first entity 126A concerned with/having knowledge regarding an ECU item 105A-n and a second entity 126B concerned with/having knowledge regarding a software/functional item 104A-n. Correspondingly, the first entity 126A (concerned with an ECU item 105A-n) can further analyze the attack paths 156A-n, while the second entity 126B (concerned with a software/functional item 104A-n) can further analyze the damage scenarios 163A-n based on the same/common threat scenario 158A-n. Accordingly, the two entities 126A and 126B can submit their respective knowledge/perform a handshake operation (per Method 12.2.), to achieve an iterative design generated from the same threat scenario 158A-n, e.g., regarding a software/functional item 104A-n being implemented on an ECU item 105A-n. Hence, a threat scenario 158A-n can be static, stable, accessible to both entities 126A and 126B, and further governed by a central entity 126C tasked with implementing the TARA tool 125 during design and implementation of system 101A-n.

Similarly attack vectors 154A-n can be considered to be static/stable (per region 2) and stored in/retrievable from the attack vector library 149. An attack vector 154A-n is a method-oriented threat. An attack vector 154A-n can be static/stable knowledge over the course of design, and can be further continuously supplemented/updated with any new information regarding identification of any new attack techniques/vulnerabilities, as identified during the design and implementation of system 101A-n.

Furthermore, the attack paths 156A-n can be considered to be dynamic (per region 3) and generated during application of the TARA tool 125, e.g., during threat/risk analysis of one or more assets 134A-n of software item 104A-n, ECU item 105A-n, and/or network item 106A-n. For example, with an attack directed towards an asset 134A of ECU item 105A, the threat scenario 158A can be defined as a spoofing attack (static/pre-defined), having an attack vector 154A-n (static/pre-defined), whereby the attack path 156A-n is determined (dynamically) during analysis with TARA tool 125. Prior to implementation of a TARA tool 125 on an attack 110A-n, the threat scenarios 158A-n can be predefined/preconfigured in threat library 150, and further, the attack vectors 154A-n can also be predefined/preconfigured in attack vector library 149. The threat scenarios 158A-n and attack vectors 154A-n can be considered to be the over-arching concepts of an attack 110A-n, while the attack paths 156A-n are determined for a particular attack 110A-n. Accordingly, in an embodiment, an attack path 156A may be unique to a particular device architecture comprising items 104A-n, 105A-n, and/or 106A-n, whereby, once an iteration has been performed, knowledge gained from analyzing the attack path 156A can be added to the historical data 190. In another embodiment, an attack path 156B may be the same/similar to a particular device architecture that has been previously analyzed by TARA tool 125, such that the attack path 156B is recognized by processes 176A-n, and pertinent historical data 190 can be applied to analysis of attack path 156B.

### 2. Assume and Define Item (Step 310)

TARA tool 125 can be configured to define respective items 104A-n/105A-n/106A-n onboard vehicle 102 with one or more of the following item types (as further described below):
(a) a function type item 104A-n (e.g., software, software function),
(b) an ECU type item 105A-n (e.g., hardware, CPU), and/or
(c) an architecture type item 106A-n (e.g., network infrastructure/topology).

Further, TARA tool 125 can be configured to create a version number/identifier for the defined item 104A-n, 105A-n, 106A-n in the TARA database 130.

TARA tool 125 can be configured to identify and retrieve (e.g., fetch) an item 104A-n, 105A-n, 106A-n from previous TARA versions/operations/implementations in TARA database 130 and/or from product design database 107A-n (e.g., in historical data 190, in memory 184), e.g., via an application programming interface (API). Identification and retrieval of an item 104A-n, 105A-n, 106A-n can be performed by the TARA tool 125 in response to an instruction 112A-n from entity 126A-n and/or automatically performed by one or more processes 176A-n, e.g., process 176A retrieves an item 105B from TARA database 130 (e.g., in memory 184/product design database 107A-n) corresponding to an item 105A currently of interest at TARA tool 125 (e.g., based on textual similarity between items 105A and 105B, respective version numbers/identifiers, and suchlike).

The item types for item(s) 104A-n, 105A-n, 106A-n, are:
2.1. An Architecture Type item 106A-n can be defined based on the domain (e.g., as identified by a domain name service (DNS)) and the various networks (e.g., as defined by a network/internet protocol (IP) address) in an E/E architecture topology in system 101A-n onboard vehicle 102. For example, an exposed domain can be defined as an item 106A, an Ethernet network between two domains can be defined as an item 106A.
2.2. An ECU Type item 105A-n can be defined based on the minimum identifiable ECU 105A-n which can be utilized to deploy and run the functional item's software code 104A-n. For example, a computing ECU 105A and a connectivity ECU 105B can be defined as two ECU type items 105A/105B, and the Ethernet 106A as a network item 106A can be defined as an operational environment for the computing ECU item 105A and the connectivity ECU item 105B.
2.3. A Function Type item 104A-n can be defined based on the minimum identifiable product function/functionality, which can interact with other product functions 104A-n by exchanging information/data. The function type item 104A-n can be implemented by a software component/set of software components 104A-n, which can be deployed in one or a set of ECUs 105A-n. For example, the headlamp turning on/off function and the headlamp remote control function can be defined as two function type items 104A and 104B. The headlamp turning on/off function 104A and the headlamp remote control function 104B can interact based on communication of headlamp control information therebetween. The software component of headlamp turning on/off function 104A will be potentially deployed in the computing ECU 105A-n, correspondingly the headlamp remote control function 104B, the computing ECU item 105A, the connectivity ECU item 105B, and the Ethernet network item 106A can be defined as an operational environment for the headlamp turning on/off function item 104A.
2.4. Rationale

The item 104A-n, 105A-n, 106A-n in TARA process 410 can be utilized to identify a scope of analysis, e.g., by defining an operational boundary and operational environment of an item 104A-n, 105A-n, 106A-n. In an embodiment, by assigning respective items 104A-n, 105A-n, 106A-n, ownership/design/implementation/review of a respective item 104A-n, 105A-n, 106A-n (e.g., the associated software 104A-n, hardware 105A-n, network 106A-n) can be assigned to a particular team of entities 126A-n to prevent cross-team ownership of software 104A-n, hardware 105A-n, network 106A-n that may lower operational efficiency of the TARA process 410 in identifying and resolving a risk 167A-n.

An item 104A-n, 105A-n, 106A-n can be defined in an early phase of designing system 101A-n, and implementation of TARA process 410. Further, item 104A-n, 105A-n, 106A-n can be defined at a high level. Furthermore, by utilizing items 104A-n, 105A-n, 106A-n (in conjunction with assigned identifiers), previous analysis of an item 104A-n, 105A-n, 106A-n performed during a prior implementation of process 410 (e.g., saved in historical data 190), particularly during the initial stage(s) of designing vehicle 102, can be subsequently utilized in a subsequent iteration of the TARA process 410 for vehicle 102, and also for implementation when designing a second vehicle (e.g., where the second vehicle is disparate to vehicle 102), thereby improving the efficiency of the TARA process 410 when designing a plurality of vehicles. In an aspect, the E/E architecture (e.g., hardware 105A-n, network 106A-n) onboard vehicle 102 and the product function (e.g., software 104A-n) can be operationally stable, such that the E/E architecture and product function can be considered as two item types, 105A-n & 106A-n, and 104A-n.

In an aspect, an ECU type item 105A-n can have a stable scope, but the deployment of different functionality 104A-n in different ECUs 105A-n in different execution environments can render the ECU type item 105A-n to be dynamic between respective design projects. Hence, the ECU item type 105A-n can be defined as classical item type.
2.5. Comparison between VCC TARA methodology and ISO/SAE 21434

Per ISO/SAE 21434, section 3.1.25, the term ‘item’ is defined as: component or set of components that implements a function at the vehicle level. Note 1 to entry: A system can be an item if it implements a function at the vehicle level, otherwise it is a component.

Hence, per ISO/SAE 21434, the term item comprises all electronic equipment and software (i.e. all components/devices in a system 101A-n) in a vehicle involved in the realization of a specific functionality at vehicle level, e.g. braking. With ISO/SAE 21434, an item or a component interacts with its operational environment. ISO/SAE 21434 further describes cybersecurity engineering from the perspective of a single item.

The ISO/SAE 21434 definition of an item is useful for ECUs 105A-n that implement a single specific function and further of use for single item analysis. However, with the continued development and implementation of software-defined vehicles 102, more platform ECUs 105A-n will be required to implement multiple functions 104A-n across a system 101A-n. Accordingly, the scope of definition under ISO/SAE 21434 for the term item is not flexible/amendable for reusing an item and associated analysis of the item(s) in a TARA process 410 for different vehicle projects, and further limits the ability for iterative development with an efficient TARA process 410.

Per the embodiments presented herein, the term item (e.g., software item 104A-n, ECU item 105A-n, network item 106A-n) is defined/utilized with a narrower, more focused scope to overcome the current shortcomings of ISO/SAE 21434. The various embodiments presented herein are directed towards achieving simultaneous TARA iteration subsequent to/following each iteration of product design/development. For example, to achieve an efficient iterative process when software 104A-n is to be reselected and/or reallocate to an appropriate/secure ECU 105A-n, to enable iterative design of an ECU 105A-n having respectively different cybersecurity controls 161A-n for each iteration, or iteratively deploy an ECU 105A-n in different E/E architectures, and suchlike.

In an aspect, defining an item 104A-n, 105A-n, and/or 106A-n 132A-n can be the first step in initializing a TARA process 410 with during the initial/low maturity stage(s) of designing a system (e.g., vehicle 102). By utilizing the function item type 104A-n, ECU item type 105A-n, architecture (in term of domains and networks) item type 106A-n, enables a higher degree of certainty during the initial stages of the TARA process 410, wherein the respective types enable stability as the respective items are utilized across vehicle variants, maximizing reuse of item analysis across respective vehicle variants and iterations of TARA process 410.

### 3. Create the Relationship Between Items (Step 315)

TARA tool 125 can be configured to:
(a) create a traceable item relationship 136A-n between items 104A-n, 105A-n, 106A-n, e.g., by identifying respective items that are interconnected across the E/E environment of vehicle 102.
(b) create a version/identification number referencing the item relationship 136A-n in TARA database 130.
(c) identify/retrieve an item relationship 136A-n from previous iterations of the TARA process 410 (e.g., in TARA database 130, product design database 107A-n, historical data 190, memory 184, and suchlike). For example:
   1) The ECU item 105A-n can relate to an architecture item 106A-n, with the architecture item 106A-n being an operational environment of the ECU item 105A-n.
   2) The functional item 104A-n can relate to an ECU item 105A-n, with an ECU item 105A-n being an operational environment of the functional item 104A-n.
   3) A first functional item 104A can relate to a second functional item 104B, with the first functional item 104A being the operational environment of the second functional item 104B.

### Rationale

Utilizing a relationship 136A-n between items 104A-n/105A-n/106A-n facilitates high-level product design concepts. An item relationship 136A-n can be concretized by detailed product implementation, for example, a detailed relationship between assets 134A-n included in respective items 104A-n/105A-n/106A-n.

With an architecture item 106A-n being considered as an operational environment of ECU item 105A-n, the architecture item 106A-n can be iteratively updated as part of a product design process, enabling, for example, improvement of deploying an ECU 105A-n in an architecture 106A-n topology. Such an approach enables cybersecurity controls 161A-n to be generated for both an architecture item 106A-n and an ECU item 105A-n.

With an ECU item 105A-n being referenced by a functional item 104A-n as an operational environment, the ECU item 105A-n can be further iteratively updated to improve product design regarding a deployment and implementation strategy for the function 104A-n in the ECU 105A-n. Such an approach enables cybersecurity controls 161A-n to be generated for both a function item 104A-n and an ECU item 105A-n.

### 4. Identify Asset (Step 320)

TARA tool 125 can be configured to:
(a) identify and tag an asset 134A-n.
(b) identify/retrieve an asset 134A-n from product design database 107A-n, e.g., by an API.
(c) create/define an asset template 133A-n, wherein the asset template 133A-n can be configured to associate/combine one or more assets 134A-n with a threat scenario 158A-n in a threat library 150, as further described in Section 6. CREATE THREAT LIBRARY (STEP 340).

In an embodiment, an asset 134A-n can have an asset function 138A-n configured to identify one or more functions performed/available at an asset 134A-n, wherein a threat scenario 158A-n can be configured to attack/compromise one or more asset functions 138A-n as part of implementing attack 110A-n.

An asset 134A-n can be identified and tagged with the following four attributes 135A-n: asset category, asset type, asset status, and asset location.
4.1. Asset Category 135A-n, wherein the asset categories can include: software, hardware, information, data flow, and operation/operating environment.

### 4.1.1. Rationale

A TARA process 410 can be applied to an asset 134A-n (e.g., an asset 134A-n can be the object on which an operation in TARA process 410 is performed). An asset 134A-n can be identified within a scope of an item 104A-n, 105A-n, 106A-n. Respective assets 134A-n can be defined in a standardized manner to enable a universally applied TARA process 410 and to further improve the consistency and understandability of the TARA process 410 across a whole organization (e.g., manufacturing plant of vehicle 102).
4.2. Asset Type 135A-n, wherein the asset types can include: generic, specific, nominal, and real type.

The ‘generic’ type represents a platform type asset, e.g., an ECU 105A-n's generic execution environment.

The ‘specific’ type represents an application type asset, e.g., a specific data/signal of information, e.g., data 103A-n.

The ‘nominal’ type can function as a name, representing an asset 134A-n in a concept phase.

The ‘real’ type represents an asset 134A-n during an implementation phase.

Note: an asset 134A-n can have more than one type. e.g., an ECU 105A-n can have both a generic type & a nominal type with regard to an execution environment asset 134A-n.

### 4.2.1. Rationale

The generic and specific asset types 135A-n can be utilized in a pair to facilitate the mapping of asset allocation relationship, e.g., specific information 103A-n in transit can instance a generic data flow. The nominal and real types can be utilized in a pair to facilitate the mapping of asset development status relationship, e.g., a nominal software concept will be implemented by a real software process.
4.3. Asset Status 135A-n, can be utilized to correlate to location of an asset 134A-n and aid understanding an operational semantic together with the asset location, e.g., in transit, at rest, in processing, installed, in execute, and suchlike.

### 4.3.1. Rationale

The Asset Status attribute 135A-n enables TARA tool 125 to assign a threat scenario 158A-n (e.g., where a threat scenario can be based on one or more threats 152A-n) to an asset 134A-n, e.g., based on an operating condition/status of the asset 134A-n. For example, a status of an information category asset 134A can be in transit, such that TARA tool 125 and/or entity 126A-n/process 176A-n can identify/fetch one or more possible threat scenarios 158A-n that can occur during an in transit operation, whereby the one or more possible threat scenarios 158A-n can comprise any of, for example: spoofing, disclosure, blocking, and suchlike, of information/data 103A-n being communicated between a pair of ECUs 105A and 105B over a network 106A.
4.4. Asset Location 135A-n can be utilized to describe the asset 134A-n's location in E/E architecture (e.g., network 106A-n) and/or in ECU (e.g., ECU 105A-n).

### 4.4.1. Rationale

The asset location attribute 135A-n can be utilized during analysis/determination of an attack path 156A-n and attack feasibility analysis (e.g., analysis of a threat scenario 158A-n being implemented).

Threat scenario 158A-n, in conjunction with one or more assets 134A-n, and respective asset attributes 135A-n, can be presented in combination per an asset template 133A-n. In an aspect, an asset template 133A-n can be configured to present the assets 134A-n, asset attributes 135A-n, and threat scenario 158A-n in a human readable format.

### 5. Create Relationship(S) Between Assets (Step 330)

TARA tool 125 can be configured to:
(a) create a traceable relationship 137A-n between two or more assets 134A-n based on the relationship between asset types 135A-n. In an embodiment, a relationship 137A-n between respective assets 134A-n can inherit the item relationship 136A-n as defined per SECTION 3: CREATE THE RELATIONSHIP BETWEEN ITEMS.
   1) A ‘specific’ asset type 135A-n can be associated with/instance a ‘generic’ asset type 135A-n. The term ‘generic’ asset type 135A-n can be concerned with a generic environment (e.g., a generic operational environment of an ECU 105A-n) while a ‘specific’ asset type 135A-n can be concerned with a specific function (e.g., software/function 104A-n) that is implemented in the generic environment. Accordingly, ‘specific’ and ‘generic’ asset types 135A-n can be considered from a product integration dimension to define a relationship between an operational environment and a specific function during implementation/an iteration of the TARA tool 125.
   2) A ‘real’ asset type 135A-n can be associated with/implement a ‘nominal’ asset type 135A-n. The ‘nominal’ and ‘real’ asset types pertain to a product maturity dimension, whereby a nominal asset type 135A-n can be an initial condition (e.g., initial operational condition of an ECU 105A-n), while a real asset type 135A-n can relate to a subsequent condition where, for example, a software/function 104A-n is deployed on the ECU 105A-n and the effect of the deployment. Real asset types 135A-n can also provide traceability of an effect of respective software/functions 104A-n over one or more iterations of TARA tool 125. Accordingly, ‘nominal’ and ‘real’ asset types 135A-n can define the relationship between a nominal/initial operational environment/operational condition and a change resulting from deploying/implementing a subsequent function 104A-n during one or more iterations of TARA tool 125.

For example, an ECU 105A-n's (having a generic asset type 135A-n and a nominal asset type 135A-n) execution environment asset 134A-n can be instanced by a software function 104A-n's specific software process asset 134A-n and can be implemented by the ECU 105A-n itself regarding a real CPU and memory asset 134A-n.
(b) create a version number identifying the asset relationship 137A-n in TARA database 130.
(c) identify and retrieve an asset relationship 137A-n from previous TARA versions (e.g., in historical data 190) in TARA database 130, from product design database 107A-n, and suchlike. For example:
   1) An ECU item 105A-n's asset 134A-n refers to an architecture item 106A-n's asset 134A-n as an operational environment.
   2) A functional item 104A-n's asset 134A-n refers ECU item 105's asset 134A-n as an operational environment.

### 5.1. Rationale

The relationship 137A-n between respective assets 134A-n enables a detailed product deployment and implementation strategy to be achieved compared with that available by implementing a product deployment/strategy using a relationship 136A-n between respective items 104A-n/105A-n/106A-n. The relationship 137A-n between respective assets 134A-n can be iteratively updated based on balancing the risk value 167A-n generated by a TARA process 410, as further described.

With an architecture asset 134A-n being referenced by an ECU asset 134A-n as an operational environment, it can be further iteratively updated to improve the product design such as ECU 105A-n deployment strategy in architecture 106A-n topology, in conjunction with updating the cybersecurity controls 161A-n for both an architecture 106A-n asset 134A-n and ECU 105A-n asset 134A-n.

With an ECU item 105A-n being referred to by a functional item 104A-n as an operational environment, it can be further iteratively updated to improve the product design/deployment and implementation strategy for a function 104A-n in the ECU 105A-n, in conjunction with updating the cybersecurity controls 161A-n for both a function 104A-n asset 134A-n and ECU 105A-n asset 134A-n.

### 6. Create Threat Library (Step 340)

TARA tool 125 can be configured to:
(a) define a threat scenario 158A-n, wherein the threat scenario 158A-n can be included in a threat library 150 based on, for example, method 6.1. below. In an embodiment, a threat scenario 158A-n can be generated from one or more threats 152A-n, attack types/vectors 154A-n, and/or attack paths 156A-n pertaining to a particular configuration/situation onboard vehicle 102 against which a threat 152A-n may be implemented.
(b) generate a threat library 150 listing all possible categories of assets 134A-n of items 104A-n, 105A-n, and/or 106A-n, as a template 133A-n and predefine all possible threat scenarios 158A-n for each category of asset 134A-n (e.g., in asset features 135A-n).
(c) define a threat scenario 158A-n, per Method 6.1. below, which enables pre-synergy between different type of items 104A-n/105A-n/106A-n and further enable exchange of information 103A-n between different types of items 104A-n, 105A-n, 106A-n.
(d) define a list of threat scenario 158A-n condition(s) (e.g., threat 152A-n, attack type/vector 154A-n, attack path 156A-n), wherein the list facilitates mapping between a threat scenario(s) 158A-n and a damage scenario(s) 163A-n, e.g., per Section 10: ANALYZE DAMAGE SCENARIO AND ASSESS IMPACT LEVEL.

### 6.1. Method

6.1.1. A threat scenario 158A-n can be defined based on, for example, a classical STRIDE model. The threats 152A-n can be categorized as (a) attack result-oriented threats 157A-n and (b) attack method-oriented threats 158A-n. Result-oriented threats 157A-n can be identified and defined for a threat scenario 158A-n, whereas attack method-oriented threats 159A-n can be identified and defined with both an attack method and an attack path portion.
6.1.1.a. The ‘Spoofing’, ‘Tampering’, ‘Denial of Service’, and ‘Information disclosure’ can be categorized as result-oriented threats 157A-n and utilized for threat scenario 158A-n description.
6.1.1.b. The ‘Escalation of privilege’ can be categorized as attack method-oriented threats 159A-n, which focus on describing how attacker 113 can penetrate to assets 134A-n by compromising authorization step by step.
6.1.1.c. ‘Repudiating’ can be identified both as attack result-oriented threat 157A-n and as attack method-oriented threat 159A-n. ‘Repudiate’ is available as a threat scenario 158A-n or an available attack step.
6.1.2. In threat library 150, the pre-defined threat scenario 158A-n can use semantic(s) that is applicable on both a ‘generic’ type attribute 135A-n asset 134A-n and a ‘specific’ type attribute 135A-n asset 134A-n. For example, for ‘generic’ data flow and ‘specific’ data of information, the threat scenario 158A-n regarding ‘Spoofing’, ‘Tampering’, ‘Denial of Service’, and ‘Information disclosure’ can be defined, per TABLE 1 below.

TABLE 1
ECU Asset template 133A and Function Asset
Template 133B and threat scenario 158A-ns.

| . ECU asset | Function asset | | |
|---|---|---|---|
| template 133A | template 133B | CS property | Threat scenario 158A-n |
| ECU 105A-n's | Function 104A- | Authenticity/ | Receiving the spoofed or |
| onboard | n's specific | Integrity | tampered data/signal of |
| communication | data/signal | | onboard communication |
| data flow | 103A-n | | message, lead to loss of |
| Category: data | information | | authenticity/integrity of the |
| flow | Category: | | message. |
| Type: | information | Confidentiality | Disclosure of the data/signal |
| ‘generic’ & | Type: ‘specific’ | | of onboard communication |
| ‘nominal’ | Status: ‘in | | message during |
| Status: ‘in | transit’ | | communication, lead to loss |
| transit’ | Location: in | | of confidentiality of the |
| Location: | ECU 105A-n | | message. |
| between ECU | | Availability | Denied of sending/receiving |
| 105A and ECU | | | the data/signal of onboard |
| 105B | | | communication message, |
| | | | lead to loss of availability of |
| | | | the message. |

6.1.3. The threat library 150 can include a list of threat scenarios 158A-n and associated condition/information, whereby the associated condition can be utilized to indicate/determine a state or situation when a threat scenario 158A-n occurs/is implemented. A description hierarchy can be applied and further defined by any of threat component 151, an entity 126A-n, process 176A-n, and suchlike. For example, description hierarchy level 1: vehicle driving status; description hierarchy level 2: vehicle driving speed.

### 6.2. Rationale

The threat scenario 158A-n can function as an anchor to link the respective assets 134A-n for the three item types 104A-n, 105A-n, and/or 106A-n, and can further function to link a damage scenario 163A-n with an attack path analysis for attack paths 156A-n. Thus, a clear and uniform way of describing a threat scenario 158A-n enables exchange of analysis information 103A-n between items 104A-n/105A-n/106A-n. Accordingly, the various embodiments presented herein enable a standardized/centralized approach to identifying and describing threat scenario 158A-n with a threat library 150.

The threat component 151/threat library 150 can be configured to identify all possible threat scenarios 158A-n on different assets 134A-n listed in the asset template 133A-n. With the high universality of a template 133A-n for assets 134A-n and threat scenarios 158A-n, the threat component 151/threat library 150 can be utilized across various vehicle projects to achieve efficient TARA processing across the respective projects. Accordingly, a core step to enabling iterative TARA based product design between different items can be achieved (e.g., via iteration component 155).

### 7. Create Cybersecurity Control Library (Step 350)

TARA tool 125 can be configured to:
(a) create/define cybersecurity controls 161A-n, and further store the cybersecurity controls 161A-n (e.g., in security library 164, at memory 184, etc., as historical data 190), e.g., per method 7.1, below. A cybersecurity control 161A-n can be generated as a conceptual approach/method/process to address, e.g., mitigate, negate, and suchlike, a potential threat scenario 158A-n.

### 7.1 Method

A cybersecurity control 161A-n can be categorized with three levels: architectural level pertaining to securing a network item 106A-n, ECU level pertaining to securing an ECU item 105A-n, and functional level pertaining to securing a software item 104A-n. For example, (a) a security gateway can be defined and categorized as architectural level cybersecurity control 161A; (b) a secure boot mechanism can be defined and categorized as ECU level cybersecurity control 161B, and (c) a message authentication mechanism can be defined and categorized as functional level cybersecurity control 161C.

### 8. Identify Threat Scenarios (Step 360)

TARA tool 125 can be configured to:
(a) for each asset 134A-n, identify and retrieve relevant threat scenarios 158A-n from threat library 150 and further assign a respective threat scenario 158A-n to the asset 134A-n based on the asset's attributes 135A-n.
(b) training of a process 176A-n based on the data/knowledge from distributed TARA process 410. Training can be based on the respective relationships mapped between the respective threat scenario(s) 158A-n and one or more attributes 135A-n of an asset 134A-n.
(c) utilize one or more processes 176A-n enable automatic identification and retrieval of relevant threat scenarios 158A-n from threat library 150 and/or assign the respective threat scenarios 158A-n to a respective asset 134A-n, and/or further suggest/identify (e.g., to entity 126A-n) any potential threat scenarios 158A-n to enable further review and selection of the relevant threat scenarios 158A-n.
(d) identify and retrieve a cybersecurity control(s) 161A-n from cybersecurity control library 164 (e.g., associated with security component 160) and further select the respective cybersecurity control 161A-n to potentially mitigate the respective threat scenario 158A-n.
(e) identify and retrieve respective conditions for a threat scenario 158A-n from threat library 150 and further implement a cybersecurity control(s) 161A-n to mitigate the threat scenario 158A-n (e.g., as determined from threat(s) 152A-n, attack type/vector 154A-n, and attack paths 156A-n).

### 8.1. Rationale

A threat scenario 158A-n can be identified for each asset 134A-n. A threat scenario 158A-n can be realized by different attack methods following different attack paths 156A-n, and based on the respective attack paths 156A-n, a respective threat scenario 158A-n can give rise to one or more disparate damage scenarios 163A-n.

A TARA process 410 utilizing different type of items 104A-n, 105A-n, and/or 106A-n, has various advantages (with reference to FIG. 2):
(a) The function type item 104A-n enables analysis of a damage scenarios/impact level associated with a threat scenario 158A-n (e.g., the logical abstraction layer 210 of FIG. 2). Further, by utilizing assets 134A-n, attack paths 156A-n can be identified. However, analysis of attack paths 156A-n/attack feasibility 450A-n associated with a threat scenario 158A-n can be performed at the item level, e.g., the ECU type item 105A-n and the network type item 106A-n enable analysis of an attack path/feasibility 450A-n associated with a threat scenario 158A-n (e.g., the physical abstraction layer 220 of FIG. 2).

An additional layer of knowledge is required to enable analysis of a damage scenario 163A-n/impact level 440A-n, e.g., of a software/function 106A-n being implemented at the ECU 105A-n/network 106A-n. The additional layer of knowledge is provided at the integration abstraction layer 230, e.g., at a time when a system comprising one or more of software 104A-n, ECUs 105A-n, network 106A-n is being implemented/integrated onboard vehicle 102. During the integration process, TARA tool 125 can review the function type item 104A-n in conjunction with the ECU item 105A-n and network item 106A-n to iteratively select an appropriate ECU 105A-n having an operation environment suitable to implement/host/handle the assets 134A-n of the function item 104A-n. Correspondingly, TARA tool 125 be configured to analyze knowledge/information regarding the function item 104A-n, ECU item 105A-n, network item 106A-n, and associated assets 134A-n to enable combining the respective elements of the physical abstraction layer 220 with the respective elements of the logical abstraction layer 210. Such interaction is difficult to achieve with a conventional TARA process, with a conventional process it is difficult to analyze/validate various assumptions for integration of any of function item 104A-n, ECU item 105A-n, network item 106A-n.

An acceptable level of system integration may require several iterations of TARA process 410 (e.g., by iteration component 155) to balance the system design, until each of function item 104A-n, ECU item 105A-n, network item 106A-n, and associated assets 134A-n have been integrated with an acceptable level of risk 167A-n/resistance to threat scenarios 158A-n across the respective assets 134A-n.

### 9. Create Damage Library (Step 370)

TARA tool 125 can be configured to:
(a) identify and define respective damage scenarios 163A-n with a damage scenario template 435A-n, and further tag each damage scenario 163A-n with different attributes 436A-n, e.g., per Method 9.1.1. below.
(b) generate one or more damage scenarios 163A-n, and further store respective damage scenarios 163A-n in a damage library 169, e.g., per Method 9.1.2. below. In an embodiment, damage library 169 can include one or more damage scenarios 163A-n, e.g., generated/compiled via TARA process 410, e.g., per Method 9.1.2. below.
(c) define a relationship between a damage scenario 163A-n and impact level assessment factors 440A-n, e.g., per Method 9.1.3., below.
(d) define a list of damage impact level assessment rules 445A-n, wherein the damage impact level assessment rules 445A-n can be utilized to generate an impact rating activity 440A-n on each damage scenario in Section 10. ANALYZE DAMAGE SCENARIO AND ASSESS IMPACT LEVEL.

### 9.1. Methods

9.1.1.: a damage scenario template 435A-n can be defined and tagged with one or more damage scenario attributes 436A-n. Damage scenario attributes 436A-n can include, for example, damage injured party, damage category, damage condition, and suchlike. In an aspect, a damage scenario template 435A-n can be configured to present a damage scenario 163A-n in a human readable format.
   (a) A damage injured party is an entity that has undergone harm, injury, or a negative effect caused by a threat scenario 158A-n incident on the entity. A damage injured party can include a product, a user (e.g., owner, driver of vehicle 102), an organization (e.g., OEM of vehicle 102), etc.
   (b) A damage category identifies different types of harm, injury, or negative effects caused by a threat scenario 158A-n incident on the entity. For example, a damage category can include: product failing, product physical damage, financial damage, privacy damage, safety damage, reputation damage, IP damage etc.
   (c) A damage condition is a state or situation when a damage scenario 163A-n occurs. For example, damage scenario 163A occurs during driving of vehicle 102.

By utilizing a damage scenario template 435A-n, various damage scenario attributes 436A-n can be combined to generate a damage scenario 162A-n. For example, a damage scenario 162A can comprise: damage injured party XX suffered damage category XX type harm/injury/negative effects with/without damage condition XX.
9.1.2. Damage library 169 (e.g., in memory 184, historical data 190) can include a list of possible damage scenario's elements based on each damage scenario attribute 436A-n. Further, a description hierarchy can be applied and further defined. For example: an ECU 105A located on vehicle 102 can be defined with an attribute 436A-n damage injured party, and further represented with details regarding one or more functions of ECU 105A, what functionality may have been lost as a function of the damage scenario 163A-n, and further description of the damaged functionality, e.g., details regarding under function performance, over function performance, loss of functionality, and suchlike.

TABLE 2
presents examples of a function 104A-n's product damage
scenarios in damage scenario template 435A-n.
Example of product function 104A-n failing list

Under/over function
Degradation of function
Unintended function
Loss of function
Illegally upgraded function
No impairment of function

For a ECU item 105A-n's asset 134A-n, a product damage scenario can be configured to present the severity of damage incurred/potentially incurred. For example, how severe is damage incurred by an ECU 105A-n (and associated network 106A-n and software 104A-n), and further, a level of effort required to repair the damage at the ECU 105A-n.

TABLE 3
presents examples of ECU/network's product damage
scenarios in damage scenario template 435A-n.
Example of ECU 105A-n/network 106A-n product damage list

Malfunction ECU/network
Reparable damage ECU/network
Irreparable damage ECU/network
Illegally upgraded ECU/network
No impairment of ECU/network

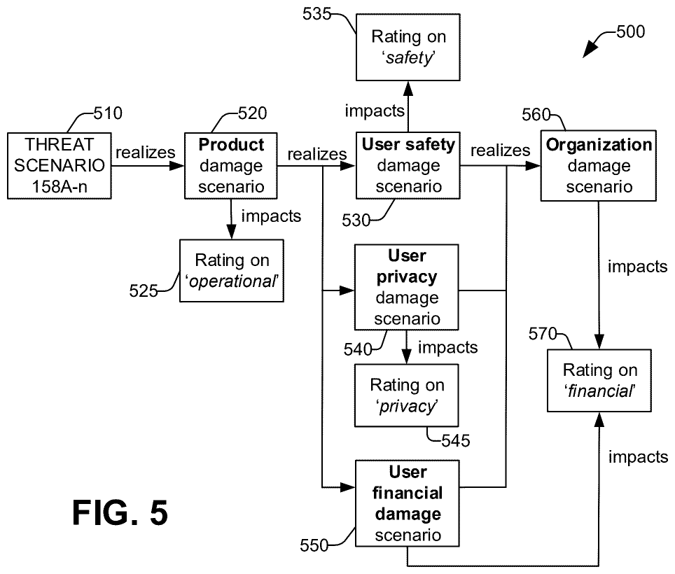

Implementing a damage scenario template 435A-n with respective elements 437A-n and attributes 436A-n, an example damage scenario 163A-n can be generated comprising: a ‘road user’ suffers ‘safety’ damage with a condition of ‘driving under 30 km/h’, or a ‘product function’ suffers ‘under function’ negative effect with a condition of ‘driving under 30 km/h’.
9.1.3. The damage impact level assessment factor 440A-n can be defined as ‘operational’, ‘safety’, ‘financial’ and ‘privacy’. In an embodiment, the impact levels 440A-n can follow the ISO 21434 standard, with the rating further following the respective relationships per FIG. 5, schematic 500, wherein FIG. 5 illustrates a threat scenario 158A-n and the respective impact on respective ‘rating’ of an assessment factor 440A-n.

FIG. 5 illustrates the relationship between a damage scenario 163A-n and an assessment factor 441A-n. An assessment factor 441A-n can comprise of:
(a) an ‘Operational’ impact level relating to a worst product damage scenario,
(b) a ‘Safety’ impact level relating to a worst user safety damage scenario,
(c) a ‘Privacy’ impact level relating to a worst user privacy damage scenario, and
(d) a ‘financial’ impact level relating to a worst synergized user financial damage scenario and organization damage scenario.

As shown in FIG. 5, effects of a threat scenario 158A-n/attack method can be complex and inter-related. A threat scenario 158A-n (at 510) can result in product damage (at 520, e.g., to vehicle 102), which can affect an operational rating (at 525, e.g., of vehicle 102). Product damage can cascade to a user safety damage scenario (at 530, e.g., affecting both a user (e.g., driver/passenger/owner and OEM of vehicle 102) which can affect a safety rating (at 535). Product damage can also give rise to a user privacy damage scenario (at 540, e.g., affecting a user of vehicle 102) which can affect a privacy rating (at 545). Product damage can also give rise to a user financial damage scenario (at 550, e.g., user of vehicle 102). The user safety damage scenario (at 530), the user privacy damage scenario (at 540), and the user financial damage scenario (at 550) can combine to affect an organization damage scenario (at 560, e.g., OEM of vehicle 102), and further affect a financial rating (at 570) of either the organization or the user of vehicle 102.

### 10. Analyze Damage Scenario and Assess Impact Level (Step 380)

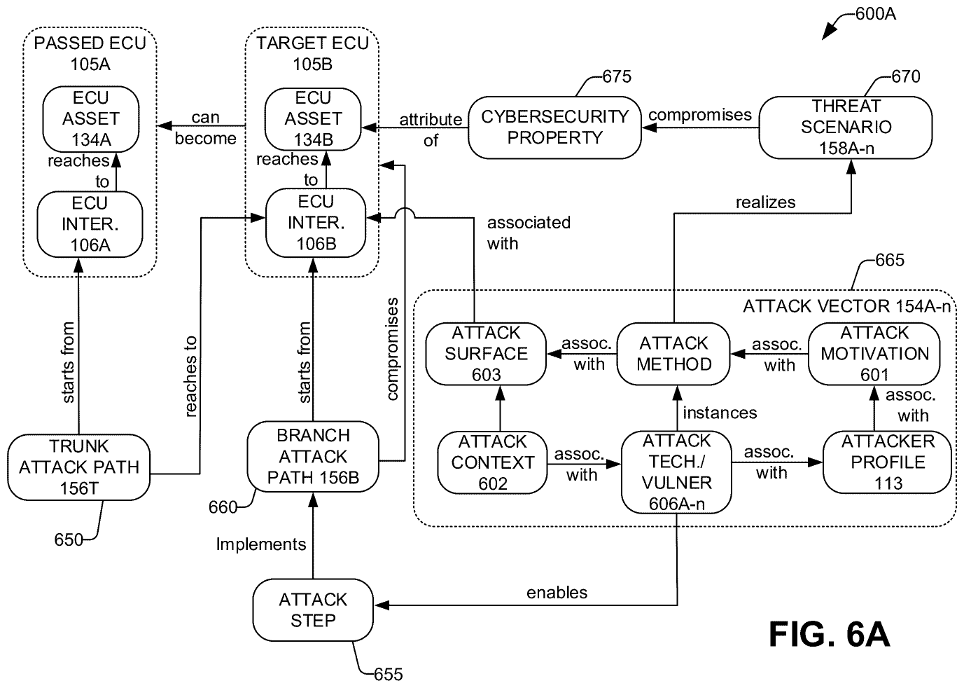

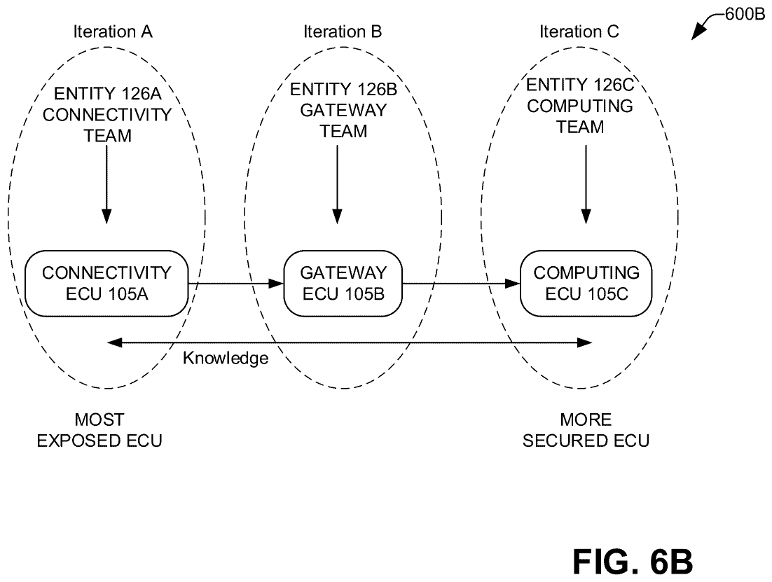

TARA tool 125 can be configured to:
(a) for each identified threat scenario 158A-n, identify/determine a damage scenario 163A-n and/or a damage impact level 440A-n, e.g., per Method 10.1, below.
(b) train a process 176A-n based on the data/knowledge derived from distributed TARA process 410, wherein training can be based on relationship mapping between a respective threat scenario 158A-n and associated attributes 436A-n of a damage scenario 163A-n.
(c) identify and/or retrieve relevant damage scenarios 163A-n (e.g., in historical data 190 in a damage library 169/memory 184) and further assign/associate the damage scenarios 163A-n to the threat scenario 158A-n, or further suggest relevant damage scenarios 163A-n to enable selection of damage scenarios 163A-n pertaining to a threat scenario 158A-n.
(d) identify and retrieve respective damage scenarios 163A-n and damage impact level 440A-n from previous iterations of the TARA process 410, e.g., historical data 190, as stored in TARA database 130, damage library 169, memory 184, etc.,
(e) review a function item 104A-n to identify and retrieve function information and ECU concept from product design database 107A-n to facilitate the damage scenario 163A-n analysis and create a relationship between the damage scenario 163A-n and an injured party (e.g., user, organization, etc., per FIG. 5) resulting from threat scenario 158A-n.
(f) for a function item 104A-n, synergize damage scenario 163A-n and impact level rating 440A-n to a failure mode and effects analysis (FMEA) database (e.g., in memory 184, or externally located to TARA system 120 and/or a HARA database, per FIG. 6A.

### 10.1. Method

10.1.1. Based on respective attributes/information 436A-n regarding a damage scenario 163A-n, TARA tool 125 can be configured to identify and retrieve (e.g., via damage component 165) a damage scenario(s) 163A-n from damage library 169 or receive a damage scenario(s) 163A-n, e.g., based on the damage scenario template 435A-n defined in Section 9: CREATE DAMAGE LIBRARY.

TARA tool 125 can be configured to rate the damage impact level 440A-n, e.g., based on one or more damage impact level assessment rules 445A-n defined in Section 9: CREATE DAMAGE LIBRARY.
10.1.2. In an embodiment, in the event of difficulty arising in assessing/analyzing a damage scenario 163A-n, e.g., a damage scenario can be difficult to assess based on available information for any of the ECU item 105A-n, the architecture item 106A-n, the function item 104A-n, as a default, the TARA tool 125 can be configured to select, from the damage library, the damage scenario 163A-n having the worst outcome (e.g., inflicts/involves the most damage, per FIG. 5) and preliminarily assess the impact of the damage scenario 163A-n.

Based on the relationship between assets 134A-n (defined in Section 5: CREATE RELATIONSHIP(S) BETWEEN ASSETS), the TARA tool 125 can be configured to identify and retrieve any relevant damage scenario 163A-n and damage impact rating 441A-n from an associated item's asset 134A-n, whereby, for example, a first item asset 134A relates to an operational environment of the second asset 134B. Such an approach enables a preliminarily assumed damage scenario 163A-n and impact level 440A-n to be validated and updated in accordance with respective iterations of TARA process 410.

In an embodiment, the impact rating 441A-n can be determined/based on the worst impact rating of all identified damage scenarios 163A-n. The identification and retrieval can be based on recognizing the same threat scenario 158A-n exists between respective assets 134A-n as defined in Section 6: CREATE THREAT LIBRARY, Method 6.1.2.

### 11. Analyze Trunk Attack Path and Attack Feasibility (Step 385)

For the respective aspects presented in section 11, the TARA tool 125 can be configured to:
(a) analyze an architecture item 106A-n to identify/analyze a trunk attack path 156T, e.g., per Method 11.1., below.
(b) identification and retrieval of a list of attack vectors 154A-n and attack paths 156A-n from previous executions of the TARA process 410 stored in TARA database 130 (e.g., in historical data 190 in memory 184).
(c) identification and retrieval of E/E architecture topology (e.g., ECU items 105A-n, network items 106A-n) from product design database 107A-n to further identify one or more attack paths 156A-n.

### 11.1. Method

11.1.1. For the respective entities 126A-n (e.g., reviewing/generating architecture items or PSIRT functionality), TARA tool 125 can be configured to interact with an entity 126A-n (e.g., an entity reviewing architecture 106A-n/hardware 105A-n) to enable creation of an attack vector library 149/threat library 150. The attack vector 154A-n refers to the attack method used by different type attackers 113 with different motivations to penetrate a vehicle 102/ECU 105 via various possible attack surfaces 603. An attack vector 154A-n can also consider/comprise information regarding, but not limited to, any of the attributes of an attack method 110A-n, an attack surface 603A-n, an attack motivation 601A-n, attack technique vulnerability 606A-n, attack context 602A-n, and/or a respective profile of a respective attacker 113. By interacting with the attack vector 154A-n/the attack vector library 149, the TARA tool 125 can be configured to enable creation of a unified list of the respective attributes of interest regarding an attack vector 154A-n, and an according threat scenario 158A-n.

The attack method (e.g., in a threat scenario 158A-n) can function as a nominal descriptive process for completing an attack task. In an embodiment, the attack method can be defined, and instanced, based on any suitable criteria, such as (a) UNECE R155 Annex 5, (b) known attack techniques, e.g., the Man-In-The-Middle attack can be defined as an attack method, (c) known vulnerabilities from a vulnerability 606A-n database, or (d) and suchlike.

Attack motivation 601A-n refers to the underlying reason or incentive that drive different type attackers to engage in attacks.

Attack context 602A-n refers to the circumstances or environment in which the attack occurs, including relevant contextual information.

Attack surface 603A-n relates to the entry point of vehicle or ECU's interface 106A-n that attacker 113 can exploit to penetrate the object. The attack surface can be categorized from different dimensions. The attack surface can be categorized as an ‘ECU level’ attack surface or ‘vehicle level’ attack surface. The attack surface 603A-n can also be categorized as a ‘physical layer’ attack surface or a ‘logical layer’ attack surface. For example, a cellular interface can be considered as an attack surface 603P at the physical layer, while a compromised application or a logical communication port can be considered as an attack surface 603C at the logical layer.

A vehicle level attack surface 603A-n can be classified based on proximity, e.g., ‘physical proximity’, ‘local proximity’, ‘adjacent proximity’, or ‘remote proximity’. Each vehicle level trunk attack path 156T can identify a worst attack vector class associated with the vehicle level trunk attack path 156T, where the worst attack vector class can be used to determine the Cybersecurity Assurance Level (CAL).

Note 1: A vehicle level attack surface 603A can be the same as an ECU level attack surface 603B, e.g., a connectivity ECU's cellular interface can be the attack surface for both a vehicle 102 and ECU 105 implemented thereon.

Note 2: In an aspect, the attack vector 154A-n represented by a threat scenario 158A-n can correlate PSIRT issues/functionality with penetration issues/functionality.

FIG. 6A, schematic 600A illustrates various aspects of a threat scenario/attack method being implemented on a vehicle, in accordance with one or more embodiments. FIG. 6A pertains to Method 11.1. FIG. 6A, comprises a series of steps 650-675 configured to take advantage of a vulnerability 606A-n at vehicle 102.

FIG. 6A presents various attack paths, etc., that can comprise an attack 110A-n against a target ECU 105A-n, with the various aspects of an attack 110A-n identified and the respective focus of the various aspects.

A focus of respective attacks can be a first ECU 105A (aka, passed ECU) and a second ECU 105B (aka, target ECU), wherein, in an embodiment, the first ECU 105A can be an initial target of an attack, while the second ECU 105B is the target of the attack. In an embodiment, first ECU 105A can have a higher vulnerability 606A-n to an attack than ECU 105B. Accordingly, an attacker 113 can initially direct an attack 110A-n at the first ECU 105A to gain access to a computer architecture, and once achieved, the attack progresses to the second ECU 105B.

The first ECU 105A can comprise a first ECU asset 134A and an ECU interface 106A, while the second ECU 105B can comprise a second ECU 134B and an ECU interface 106B.

In an embodiment, at 650, a trunk attack path 156T can be initially directed at the first ECU 105A (e.g., via ECU interface 106A) and then further progresses/reaches the interface 106B of the second ECU 105B. As shown, once a respective ECU interface 106A/106B has been reached/compromised, the attack can reach the respective ECU asset 134A/134B.

In another embodiment, an attack step 655 can, at 660, implement a branch attack path 156B (e.g., branching from the trunk attack path 156T), whereby the branch attack path 156B can be directed towards the target ECU interface 106B, while comprising one or more aspects (e.g., ECU asset 134B) of the target ECU 105B.

In another embodiment, per 665, an attack vector 154A-n can comprise/be based on respective features, including, an attack motivation 601, a profile of attacker 113, an attack surface 603, an attack context 602, an attack technique & vulnerability 606A-n, and an attack method 110A-n. As shown, the attack vector 154A-n can be directed at the ECU interface 106B.

In a further embodiment, at 670, an attack method 110A-n can realize a threat scenario 158A-n, whereby the threat scenario 158A-n can be directed towards a cybersecurity property (at 675), wherein the cybersecurity property can be an attribute 135A-n of the ECU asset 134B.

FIG. 6B, schematic 600B, illustrates respective entities interacting with respective components, in accordance with an embodiment. As shown in FIG. 6B, in a device for implementation on a vehicle 102, connectivity ECU 105A is connected to a gateway ECU 105B, with computing ECU 105C being the target of an attack 110. A first entity 126A in an ECU connectivity team is applying TARA tool 125 to connectivity ECU 105A (iteration A), entity 126B in a gateway ECU team is applying TARA tool 125 to gateway ECU 105B (iteration B), and entity 126C in a computing team is applying TARA tool 125 to the computing ECU 105C (iteration C). As knowledge is derived from each iteration, the effect of latest knowledge can be applied across the system. For example, iteration A applied to connectivity ECU 105A provides knowledge/status K1 for connectivity ECU 105A. Iteration C applied to computing ECU 105C provides knowledge/status K3 for the computing ECU 105C. However, the knowledge K3 (e.g., apply an improved cybersecurity control 164A at ECU 105C) can affect the prior determined knowledge K1 for ECU 105A. Accordingly, as the effect of an improvement is assessed for a particular item, e.g., ECU 105C, the effects of that improvement can be seen on another item, e.g., ECU 105A.
11.1.3. TARA tool 125 can be configured, for a threat scenario 158A-n against a vehicle 102, to:
(a) create, for issues relating to an architecture item 106A-n, a relationship(s)/association between the ECU level attack surface 603 and the vehicle level attack surface 603. For example, the ECU level attack surface 603 of DoIP port can be associated to the vehicle level attack surface 603 of OBD-II.
(b) for issues relating to an architecture item 106A-n, identify and/or analyze the trunk attack path 156T at vehicle level, e.g., per RULE 9.1.4.a. below.
(c) assign an ID to the identified trunk attack path 156A-n.

The trunk attack path 156T can be used to analyze how an attacker 113 can execute/implement one or more potential vehicle level attack surface 603 on one or more target ECUs 105A-n located/operating in different domains based on the topology of E/E architecture at vehicle 102.

11.1.4.a. Rule

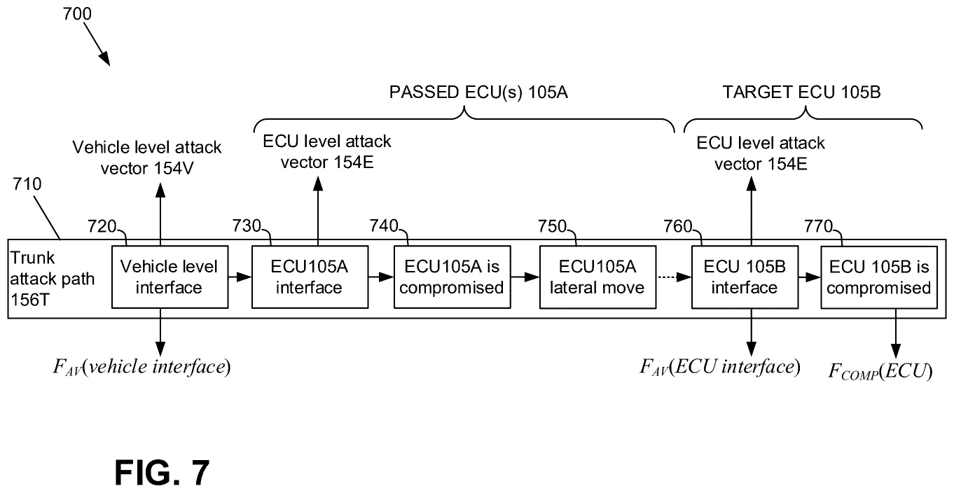

Rule 11.1.4.a. can be read in conjunction with FIG. 7, schematic 700, depicting a trunk attack path, in accordance with an embodiment. Per FIG. 7, a trunk attack path 156T starts from a vehicle level attack surface 603 (at 710/720) and ends at the target ECU 105B (at 770), e.g., via an interface of ECU 105B (e.g., at 760). The trunk attack path 156T may pass through various ECUs (e.g., ECU 105A) and networks (e.g., network 106A) based on possible E/E architecture topology present on vehicle 102 (e.g., 730-750). For each passed ECU 105A-n and network 106A-n, three statuses can be considered, a) ‘initial access’ of the ECU 105A via the ECU level attack surface 603, b) ECU 105A has been ‘compromised’, and/or c) a ‘lateral move’ to another ECU (e.g., ECU 105B) or network (e.g., network 106A-n). In an aspect, regarding analysis of a target ECU 105B, the ‘lateral move’ status does not apply (e.g., at 770). For example, there is no lateral move to be performed when the target ECU 105B is reached.

In an embodiment, the direction of trunk attack path 156T can be from a first ECU 105A having a higher compromised level of feasibility 450A-n towards a second ECU 105B having a lower level of compromised feasibility 450A-n. Such an approach can avoid generation of an infinite loop of trunk attack path 156T at an architecture level. The feasibility 450A-n of a trunk attack path 156T is further described below.
11.1.4. Note 1: a switch or gateway which implements a network function can be considered as an ECU 105A-n in trunk attack path 156T.
11.1.5. TARA tool 125 can be configured to:
(a) e.g., for an architecture item 106A-n, rate and/or assume attack feasibility 450A-n on one or more portions of a trunk attack path 156T having an attack potential-based approach or other feasibility rating approaches.
(b) rate attack feasibility 450A-n of a vehicle level attack vector FAV (vehicle interface (m)), m=1, 2, 3, . . . (e.g., at 720) where AV represents Attack Vector 154A-n.
(c) assume attack feasibility 450A-n of ECU (e.g., ECU 105A-n) has been compromised F_{Compromise}(ECU) (e.g., at 770).
(d) e.g., for an architecture item 106A-n, calculate an accumulated feasibility 450A-n of reaching to the target ECU 105A-n's interface, namely the feasibility 450A-n of ECU level attack vector 154V, per Equation 1, as follows:

$${F}_{AV} ( target ECU interface ( n ) ) = min \{ {F}_{AV} ( vehicle interface ( m ) ) , {F}_{Compromise} ( passed ECU ( i ) ) \} , n , m , i = 1 , 2 , 3 , … \qquad ( Equation 1 )$$

Note: A target ECU 105A-n can be identified as a passed ECU for a subsequently attacked target ECU 105A-n.
11.1.7. TARA tool 125 can be configured to:
(a) e.g., for an architecture item 106A-n, identify one or more threatening trunk attack paths 156T directed toward a target ECU 105A-n, e.g., based on the feasibility 450A-n of ECU level attack vector 154V.
(b) configure a judgement standard (e.g., low, medium, high risk in TABLE 4.) on whether a trunk attack path 156T would be threatening. For example, in the event of any trunk attack path 156T with the path set {F_{AV}(vehicle interface (m)), F_{Compromise}(passed ECU (i))} has a feasibility 450A-n≥medium threat, then such trunk attack path 156T can be considered as a threatening path attack.

Note: With each iteration of TARA process 410, a vehicle level trunk attack path 156T can be further iteratively tuned based on updated attack feasibility ratings 450A-n at an ECU 105A-n, enabling a corresponding validation of whether a design of architecture topology (e.g., ECUs 105A-n, network(s) 106A-n) is secure enough to resist a threat scenario 158A-n.

### 12. Analyze Branch Attack Path and Attack Feasibility (Step 390)

TARA tool 125 can be configured to:
(a) e.g., for an ECU item 105A-n, analyze a branch attack path 156A-n (e.g., branch attack path 156B) e.g., per method 12.1, below.
(b) identify and/or retrieve (e.g., from threat library 150, historical data 190, memory 184) of a list of attack vectors 154A-n and attack paths 156A-n from a previous implementation/iteration of a TARA process 410.
(c) e.g., for an ECU item 105A-n, identify and/or retrieve ECU architecture topology (e.g., ECU item 105A-n, network 106A-n) from product design database 107A-n to facilitate identification of a branch attack path 156B.
(d) e.g., for a function item 104A-n, identify and/or retrieve an attack path 156A-n directed towards an operational environment's asset 134A-n, e.g., as associated with an architecture item 106A-n and/or ECU item 105A-n.

### 12.1. Method

12.1.1. For an ECU item 105A-n, TARA tool 125 can be configured to identify and/or retrieve known attack methods/threat scenarios 158A-n from the attack method library 150 and further update the attack method library 150 with any newly identified attack method/threat scenario 158A-n.
12.1.2., this method step can be read in conjunction with FIG. 6A, schematic 600, depicting an attack method. For an ECU item 105A-n, TARA tool 125 can be configured to identify and analyze the ECU level attack vector 154A-n and the branch attack path 156A-n based on the retrieved known threat scenario 158A-n. Further, TARA tool 125 can be configured to identify/assign an ID to the identified branch attack path 156B.

The branch attack path 156B can be configured to enable analysis regarding how an attacker 113 can penetrate vehicle 102 using the ECU level attack vectors 154A-n that utilize a step-by-step approach to gain higher level permissions to compromise a desired ECU 105A and further attack other ECUs 105B-n. The branch attack path 156B can be identified based on an attack model with sequential attack steps.

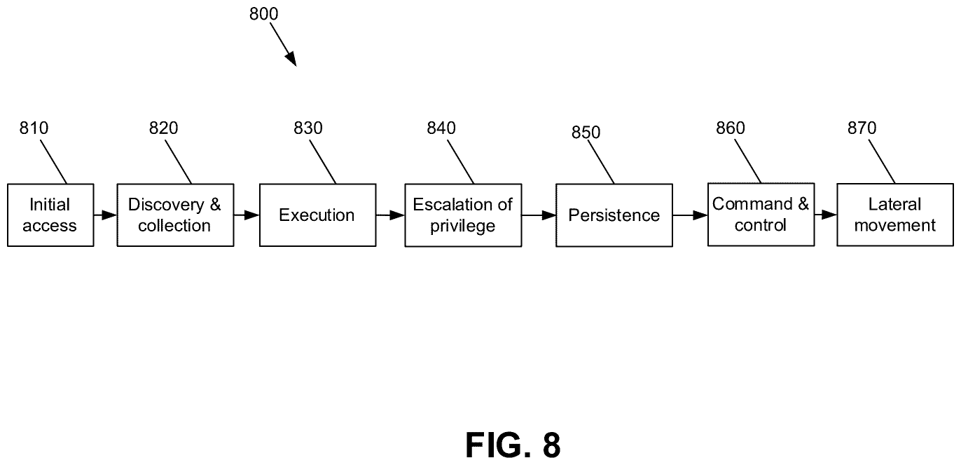

The reference attack model 800 presented in FIG. 8 (as further described below) provides an overview of a threat scenario 158A-n being implemented as an attack method/scenario. TARA tool 125 can be configured (e.g., in conjunction with any of threat component 151, security component 160, damage component 165, process component 170, an entity 126A-n, and suchlike) update the attack model 900 as knowledge of the respective attack methods are identified for respective threat scenarios 158A-n.

### 12.1.2.2. Reference Attack Model for Branch Attack Path

FIG. 8, schematic 800 presents an attack model for a branch attack path. A branch attack path 156B can follow below sequential attack steps 12.1.2.2.a.-12.1.2.2.g.
12.1.2.2.a. (Step 810): The ‘Initial access’ step is directed to accessing an ECU interface, e.g., via an ECU level attack vector 154A-n. The ‘Initial Access’ step 810 is attempting to access/breach an ECU 105A-n/network 106A-n by various ECU/network level attack vectors 154A-n, by implementing one or more attack methods (e.g., threat scenarios 158A-n) to take advantage of one or more vulnerabilities that may exist at the ECU 105A-n/network 106A-n topology. An ECU/network level attack vector 154E can be implemented in association with a vehicle level attack vector 154V. In a first example, an ECU/network level attack vector 154E can comprise of unauthorized ‘Initial Access’ to an ECU 105A by exploiting JTAG vulnerability 606A-n, while the associated vehicle level attack vector 154V is directed to physically accessing ECU 105A-n's physical ports with dissembling vehicle. In a second example, an ECU/network level attack vector 154E can comprise of unauthorized ‘Initial Access’ to an ECU 105A via ECU 105A's DoIP port: 13400 by exploiting a diagnostic vulnerability 606A-n, while the associated vehicle level attack vector 154V is directed to locally accessing vehicle 102's on-board diagnostics system.
12.1.2.2.b. (Step 820): The ‘Discovery & collection’ step is configured to obtain knowledge of an ECU 105A-n. For example, discover an ECU's 105A-n IP address and MAC address by sniffing network 106A-n, collect status information of ECU 105A-n, and suchlike.
12.1.2.2.c. (Step 830): The ‘Execution’ step is configured to execute malicious code 110A-n to generate one or more system vulnerabilities at vehicle 102 to enable further attacks on an ECU 105/network 106. For example, leveraging one or more APIs to change vehicle 102's operating model to a programming model to enable an escalate privilege-based operation/attack, per the next step (step 840).
12.1.2.2.d. (Step 840): The ‘Escalation of privilege’ step is configured to obtain higher-level permissions/access of an ECU 105A-n/network 106A-n. For example, in a Linux-based ECU 105L, attacker 113 executes a higher-level shell script by exploiting vulnerabilities of software 104A-n. In an aspect, with an attacker 113 achieving this step, ECU 105A-n/network 106A-n can be considered as being compromised.
12.1.2.2.e. (Step 850): The ‘Persistence’ step is configured to avoid detection/suspicion of an attack 110A-n being conducted to enable a foothold to be maintained by attacker 113 at the compromised ECU 105A-n/network 106A-n for as long as possible. For example, an attacker 113 leverages access credentials to enable the attacker 113 (as an unauthorized user) to continue to appear as an authorized interactive entity 126A-n at an infotainment system (e.g., ECU 1051).
12.1.2.2.f. (Step 860): The ‘Command & control’ step is configured to command and/or control a compromised ECU 105/network 106. For example, to compromise a certain cybersecurity property of an ECU/network asset 134A-n. In another example, to further access/attack other ECUs 105B-n that are connected to the initially attacked/compromised ECU 105A-n (e.g., per next step (step 870)). In a further example, an attack 110A-n can involve controlling a compromised infotainment ECU 105A to send a malicious command/instruction/operation to other ECUs 105B-n by communicating over a dedicated port to bypass firewall at network 106A-n.
12.1.2.2.g. (Step 870): The ‘Lateral movement’ step is configured to further access/attack other ECUs 105B-n based on the compromised ECU 105A. A ‘Lateral movement’ step can interface to a trunk attack path 156T. For example, lateral move from a compromised infotainment ECU 105A towards more secured computing ECU 105B, over a dedicated port to bypass a firewall at network 106A-n.
12.1.3. For an ECU item 105A-n, TARA tool 125 can be configured to create a traceable relationship between an attack step (e.g., steps 810-870) and known attack technique/vulnerability 606A-n from the attack vector library 149.
12.1.4. For an ECU item 105A-n, TARA tool 125 can be configured to add, skip, or repeat any attack steps 810-870 in attack model 800. Step 910, the first step of ‘Initial access’, can create a new branch attack path 156B.
12.1.5. For an ECU item 105A-n, TARA tool 125 can be configured to identify and/or retrieve a cybersecurity control 161A-n from cybersecurity library 164 (e.g., via security component 160), and further allocate cybersecurity control 161A-n to mitigate the attack step 810-870. Further, TARA tool 125 can be configured to create a version number/identifier to record the allocated cybersecurity control 161A-n.
12.1.6. For an ECU item 105A-n, TARA tool 125 can be configured to create a traceable relationship between the first step 810, ‘Initial access’ to the ECU 105A-n and the ECU level attack vector 154E in trunk attack path 156T (per FIG. 7). And further create a traceable relationship between the step 860 ‘Command & control’ on the ECU 105A-n and the part of ‘ECU is compromised’ in trunk attack path 156T (per FIG. 7).
12.1.7. For ECU item's 105A-n, TARA tool 125 can be configured to identify and/or retrieve the feasibility 450A-n of ECU level attack vector 154E from trunk attack path 156T and utilize feasibility 450A-n of ECU level attack vector 154E for the feasibility 450A-n of first step 810 ‘Initial access’.
12.1.8. For ECU item's 105A-n, TARA tool 125 can be configured to rate the feasibility 450A-n on the first step ‘Initial access’ with allocated cybersecurity control 161A-n, if available. Further, rate the feasibility 450A-n on the other attack steps 820-830 (except the first ‘Initial access’ step 810) with and without allocated cybersecurity control 161A-n respectively.
12.1.9. For ECU item's 105A-n, TARA tool 125 can be configured to calculate the feasibility 450A-n of each branch attack path 156B, per Equation 2, below.

The feasibility 450A-n of a branch attack path 156B depends on the lowest feasibility 450A-n of any attack step with or without allocated cybersecurity control 161A-n, namely it depends on the hardest attack step 810-870 along the branch attack path 156B.

$${F}_{B A P} ( ECU interface ) = min \{ {F}_{w / wo CC} ( Attack Step ) \} \qquad Equation 2$$

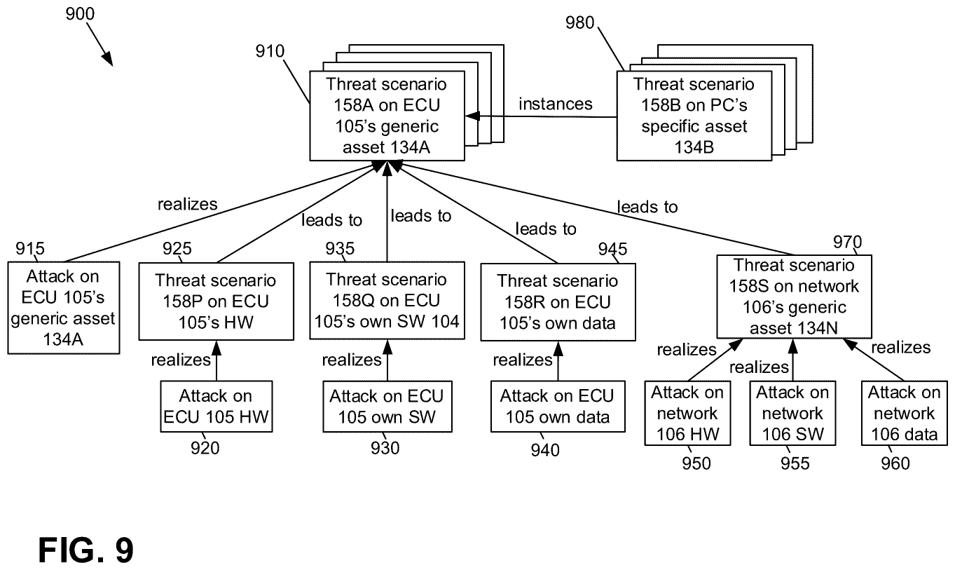

Note: w/wo CC represents with or without cybersecurity control 161A-n.
12.1.10. For ECU items 105A-n, TARA tool 125 can be configured to create a traceable relationship between an attack step 810-870 and the threat scenario 158A-n on an ECU's asset 134A-n. FIG. 9, schematic 900 illustrates respective attack steps and threat scenarios on an ECU asset, in accordance with an embodiment.

As shown in FIG. 9, at 910, a threat scenario 158A can be incident on ECU 105's generic asset 134A. One or more attacks can give rise to the threat scenario 158A-n implemented against asset 134A, for example:
a) per 915, an attack 110A-n can be implemented directly on the asset 134A;
b) per 920 and 1025, an attack 110A-n on ECU 105's hardware (HW) realizes a threat scenario 158A-n on ECU 105's HW;
c) per 930 and 935, an attack 110A-n on ECU 105's software (SW 104A-n) realizes a threat scenario 158A-n on ECU 105's SW;
d) per 940 and 945, an attack 110A-n on ECU 105's data (data 103A-n) realizes a threat scenario 158A-n on ECU 105's data 103A-n;
e) per 950, 955, 960, and 970, an attack 110A-n on network 106A's HW, SW 104A-n, and/or data 103A-n realizes a threat scenario 158A-n on network 106A's generic asset 134N; and/or
f) per 980, a threat scenario 158F on a PC's specific asset 134B can also give rise to a threat scenario 158A at the ECU 105's generic asset 134A.
12.1.11. For the ECU items 105A-n, TARA tool 125 can be configured to calculate a feasibility 450A-n of a threat scenario 158A-n occurring, and further rate the feasibility 450A-n of a threat scenario 158A-n occurring when an associated cybersecurity control 161A-n is implemented, in the event of the cybersecurity control 161A-n being available (See Section 8: IDENTIFY THREAT SCENARIOS).

In an aspect, the feasibility 450A-n of a threat scenario 158A-n implement on an ECU asset 134A-n can depend on the highest feasibility 450A-n of any branch attack path (BAP) 156B with or without an associated cybersecurity control 161A-n implemented. In an aspect, the feasibility 450A-n of a threat scenario 158A-n occurring can depend on the easiest attack path 156A-n available to implement the threat scenario 158A-n, as presented in Equation 3, below.

$${F}_{TS} ( ECU asset ) = max \{ {F}_{B A P} ( ECU interface ) \} \qquad Equation 3$$

12.1.12. For a function item 104A-n, TARA tool 125 can be configured to assume/predict the feasibility 450A-n of a threat scenario 158A-n occurring, e.g., per Method 12.2, below.

### 12.2. Method

To assume the feasibility 450A-n on a threat scenario 158A-n, TARA tool 125 can identify potentially acceptable risks value 167A-n (See Section 13: GENERATE RISK VALUE AND ITERATE PRODUCT DESIGN WITH VERSION CONTROL) to determine attack feasibility 450A-n and utilize the attack feasibility 450A-n as a cybersecurity requirement when determining how to potentially implement/deploy ECUs 105A-n.

For example, a threat scenario 158A-n has a damage impact level 440A-n that is assessed as ‘major’, with an associated acceptable level of risk 167A-n being at least “2”, then the acceptable feasibility 450A-n/risk 167A-n of such threat scenario 158A-n shall be at least at “Low” based on the Risk matrix 168 presented in TABLE 4 (e.g., wherein the Risk matrix 168 is generated in accordance with any pertinent specification, e.g., ISO 21434). Correspondingly, an entity 126A-n (e.g., concerned with a function item 104A-n) can provide requirements to its operational environment's asset 134A-n, such as “any threat scenario 158A-n occurring on asset 134A-n shall have a Risk level rating 167A-n of at the most, low level.” Accordingly, risk component 166 can be configured to compare a determined risk value 167A-n with threshold values 172A-n to determine, for example, whether the level of a first risk 167A is of concern, whether first risk 167A is of less concern than other risk values 167B-n, etc., based on the threshold values 172A-n. Based upon the risk 167A-n versus threshold risk value 172A-n, the respective risks 167A-n can be ranked, and further determination made regarding which potential risks 167A-n need to be prioritized for risk reduction (e.g., by mitigation activity 162A-n).

TABLE 4
RISK MATRIX 168 (EXAMPLE THRESHOLD
VALUES 172A-n FOR RISKS 167A-n)

| | | ATTACK FEASIBILITY RATING | | | |
|---|---|---|---|---|---|
| | | 450A-n | | | |
| | | Very Low | Low | Medium | High |
| IMPACT | Severe | 2 | 3 | 4 | 5 |
| RATING | Major | 1 | 2 | 3 | 4 |
| 441A-n | Moderate | 1 | 2 | 2 | 3 |
| | Negligible | 1 | 1 | 1 | 1 |

12.1.13. For a function item 104A-n, TARA tool 125 can be configured to validate feasibility 450A-n of threat scenario 158A-n occurring, e.g., by identifying and/or retrieving information 103A-n regarding the operational environment's asset 134A-n of software 104A-n, wherein the asset 134A-n pertains to ECU item 105A-n on which the software 104A-n executes. The identification and/or retrieval can be based on Section 6: CREATE THREAT LIBRARY, Method 6.1.2.
   13. Generate Risk Value and Iterate Product Design with Version Control (Step 395)

TARA tool 125 can be configured to follow ISO/SAE 21434 standard.

TARA tool 125 can be configured to:
(a) generate a risk value 167A-n for each threat scenario 158A-n occurring on each asset 134A-n, and correspondingly decide/implement risk treatments, e.g., one or more mitigation strategies/activities 162A-n.
(b) implement iterative product design of vehicle 102 and the onboard infrastructure/systems, e.g., per Method 13.1, below. In an embodiment, respective iterations can be performed (e.g., by iteration component 155) until all of the mitigation strategies 162A-n converge on/become a particular treatment option level (e.g., as defined by entity 126A-n). For example, all the mitigation strategies 162A-n converge on ‘sharing the risk’, ‘retaining the risk’, and suchlike.

### 13.1. Method

13.1.1. while performing respective iterations (e.g., by iteration component 155), one or more cybersecurity controls 161A-n can be added or deleted, e.g., per Method 12.1.5. of Section 12: ANALYZE BRANCH ATTACK PATH AND ATTACK FEASIBILITY.
13.1.2. while performing respective iterations (e.g., by iteration component 155), an operational environment can be selected/reselected in accordance with a deployment strategy, as defined in the methods presented in Section 3: CREATE THE RELATIONSHIP BETWEEN ITEMS and Section 5: CREATE THE RELATIONSHIP BETWEEN ASSETS.

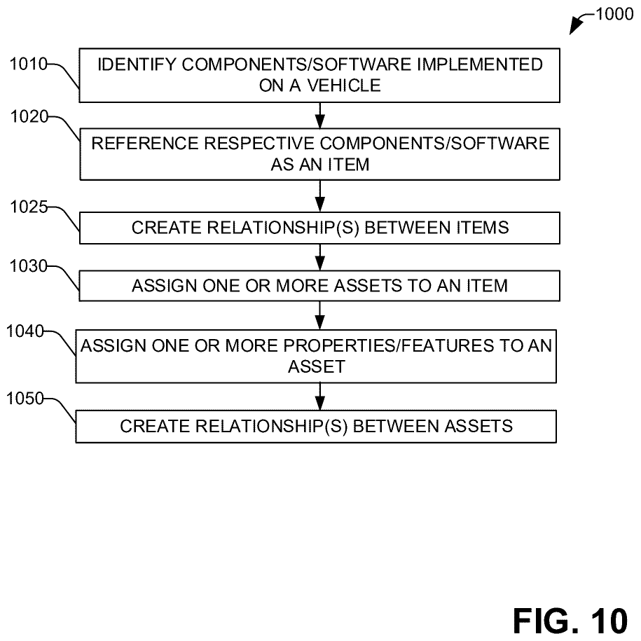

FIG. 10-13, flowcharts 1000-1300 show respective stages of implementing a TARA process 410. While FIGS. 10-13, flowcharts 1000-1300 are presented individually to capture/convey respective aspect, FIGS. 10-13 can be read in combination such that a concept presented in any of FIGS. 10-13 is applicable to any of the concepts presented in a different FIG. 10-13.

FIG. 10, flowchart 1000, presents a computer-implemented method for identifying respective items that can be included/implemented during design of a vehicle, in accordance with one or more embodiments.

At 1010, a centralized TARA system (e.g., TARA system 120) can be configured to receive information regarding one or more components/software can be identified for potential inclusion in a vehicle (e.g., vehicle 102). Information regarding the components/software can be received from a product design database (e.g., PCD 107A-n). The one or more components/software can be provided regarding a potential system (e.g., a system 101A-n, a software defined system, and suchlike).

At 1020, the respective components and software can be referenced as items (e.g., software item 104A-n, hardware/ECU item 105A-n, network/infrastructure 106A-n) at the TARA system. The TARA system can comprise multiple components configured to perform TARA analysis, including a TARA tool component (TARA tool 125).

At 1025, the TARA tool can be configured to generate respective relationships/associations (e.g., relationships 136A-n) between two or more items (e.g., items 104A-n, 105A-n, and/or 106A-n).

At 1030, the TARA tool can be configured to assign one or more assets (e.g., assets 134A-n) to a respective item. As previously mentioned, a cyber-attack against the vehicle can be directed at one or more assets.

At 1040, one or more properties/features (e.g., asset attributes 135A-n) can be respectively assigned (e.g., by TARA tool 125) to a respective asset.

At 1050, a relationship/association 137A-n can be generated (e.g., by TARA tool 125) between two or more assets 134A-n.

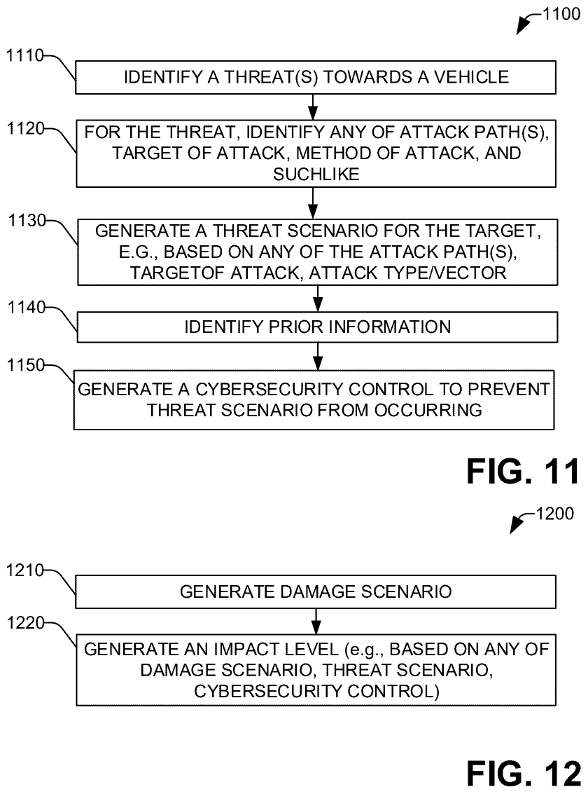

FIG. 11, flowchart 1100, presents a computer-implemented method for identifying one or more threats that can be implemented against a vehicle, in conjunction with one or more cybersecurity controls that can be implemented to mitigate/negate the one or more threats, in accordance with an embodiment.

At 1110, respective threats (e.g., threats 152A-n) can be identified (e.g., by TARA tool 125), e.g., as part of simulating various attacks (e.g., cyberattacks 110A-n) on a vehicle (e.g., vehicle 102).

At 1120, further information/data (e.g., data 103A-n) can be generated/compiled (e.g., by TARA tool 125) regarding the one or more threats, e.g., information regarding how a threat can be applied to the vehicle, one or more attack paths that can be implemented to facilitate execution of a threat. A threat can be implemented at an ECU (e.g., ECU 105A), via one or more attack paths (e.g., attack paths 156A-n) across one or more ECUs. An attack path can be directly implemented against a target component (e.g., ECU 105A), while an attack path can also comprise a trunk attack (e.g., a trunk attack path 156T) as well as one or branch attack paths (e.g., series of branch attack paths 156B) implemented across a network/infrastructure (e.g., a network 106A-n) communicatively coupling a series of ECUs together, affecting execution/operation of a software (e.g., software 104A-n executing on an ECU 105A-n/controlling operation of a network 106A-n, generation/transmission of data/information 103A-n), and suchlike. Information/data regarding threats can also include attack types/vectors (e.g., attack type/vectors 154A-n) can also be generated/compiled regarding how a particular threat may be executed at a target or across an attack path.

At 1130, the respective threats, attack paths, attack types/vectors, and information/data pertaining thereto can be compiled to generate a threat scenario (e.g., threat scenario 158A-n), wherein a threat scenario can be generated as a potential attack method to be implemented against the vehicle. Hence, a threat scenario can be generated in an arbitrary/agnostic manner, whereby the threat scenario is generated as a concept that can be deployed against, as yet, unidentified software/hardware/network which may be implemented into the vehicle. In another embodiment, a threat scenario can be generated based on knowledge regarding specific software/hardware/network, such that the threat scenario is specifically compiled/generated to perform an attack against a specific ECU, a series of ECUs (e.g., connected by a network, wherein the respective attack can follow an attack path 156A-n to the target ECU, etc.). For example, processes (e.g., processes 176A-n) can be implemented (e.g., by threat component 151 in conjunction with process component 170) to generate threat scenarios 158A-n that can be applied to a particular ECU in a particular network, with a particular instance of software executing thereon.

At 1140, previously determined threats, attack paths, attack types/vectors, threat scenarios, and suchlike, in conjunction with pertinent information such as ECUs, software, network, can be saved (e.g., by threat component 151) as historical data (e.g., historical data 190 in threat library 150/memory 184). Further, the previously determined threats, attack paths, attack types/vectors, threat scenarios, can also be identified and retrieved (e.g., by threat component 151 in conjunction with processes 176A-n) in response to determining a current ECU, software, and/or network has similarity to a previously identified ECU, software, and/or network. Accordingly, any previously determined threat, attack path, attack type/vector, threat scenario can be retrieved and implemented as part of an analysis of a potential threat scenario.

At 1150, in an embodiment, previous and currently determined threat scenarios can be utilized to determine/generate one or more cybersecurity controls (e.g., cybersecurity controls 161A-n) to prevent a threat scenario from occurring against an ECU, software, network.

FIG. 12, flowchart 1200, presents a computer-implemented method for determining/identifying one or more damage scenarios arising from a threat, and further determining a level of impact, in accordance with one or more embodiments.

At 1210, one or more damage scenarios can be generated. In an embodiment, a damage scenario can be generated from a threat scenario comprising an attack method (e.g., any of threat 152A-n, attack type/vector 154A-n, attack path 156A-n), where no cybersecurity control is available/generated (either previously or currently) to mitigate one or more effects of the threat scenario. In another embodiment, a damage scenario can be generated for a threat scenario, where at least one cybersecurity control is available/generated (either previously or currently) to mitigate one or more effects of the threat scenario.

At 1220, based on the respective damage scenario in combination with the respective threat scenario and availability of a mitigating cybersecurity control, determine an impact level (e.g., damage impact level 440A-n) of the respective damage scenario.

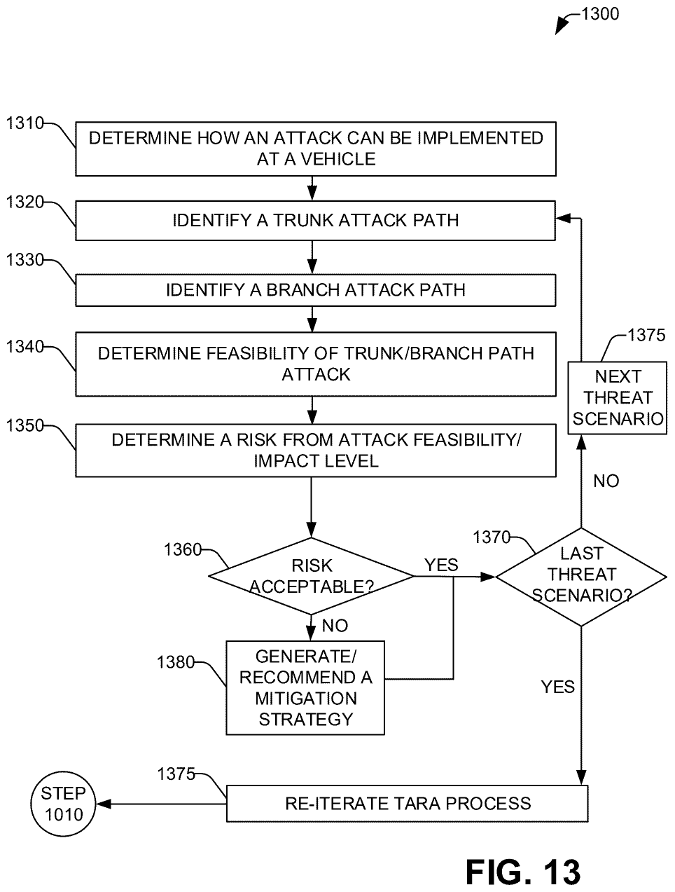

FIG. 13, flowchart 1300, presents a computer-implemented method for identifying one or more attacks that can be implemented against a vehicle, determining a feasibility of the attack, and further determining a level of risk arising from an attack, in accordance with an embodiment.

At 1310, the respective threat scenario can also be utilized to determine how an attack would be implemented against a vehicle (e.g., vehicle 102), e.g., with regard to whether a target component/software (e.g., any of software 104A-n, ECU 105A-n, network 106A-n) can be directly attacked or whether an attack is implemented at the target via one or more ECUs (e.g., passed ECUs), across the network, modifying operation of a software execution, etc.

At 1320, a trunk attack path (e.g., trunk attack path 156T) can be identified.

At 1330, a branch attack path (e.g., branch attack path 156B) emanating from the trunk attack path can be identified.

At 1340, the feasibility 450A-n of the one or more attack path(s) occurring can be determined (e.g., by TARA tool 125, damage component 165, risk component 166, process component 170, and suchlike). In an example, the attack feasibility 450A-n can have the values of very low, low, medium, high (e.g., per risk matrix 168).

At 1350, based on the attack feasibility 450A-n and the impact level (per FIG. 12), a risk (e.g., risk 167A-n) can be determined (e.g., by risk component 166 and/or in conjunction with process component 170).

At 1360, a determination can be made regarding whether the determined risk is acceptable or not. At 1360, in response to a determination (e.g., by TARA tool 125, risk component 166, etc.) that YES, the determined risk is acceptable, method 1300 can advance to step 1370, whereupon a determination can be made regarding whether the threat scenario currently being reviewed is the last in a current list of threat scenarios to be reviewed (e.g., threat scenario is one of many pertaining to an attack 110A-n).

At 1370, in response to a determination that the threat scenario is not the last threat scenario to be reviewed, method 1300 can advance to 1375, whereupon the next threat (e.g., threat scenario 158A-n) can be assessed, with method 1300 returning to step 1320 for the next attack path/branch path to be reviewed.

At 1370, in response to a determination (e.g., by TARA tool 125, threat component 151) that the current threat scenario is the last threat scenario to be reviewed in the current attack (e.g., in attack 110A-n), method 1300 can advance to step 1375, whereupon the TARA process (e.g., TARA process 410) can undergo an update/iteration, whereupon on changes, mitigation strategies, etc., that have been implemented to address one or more threats in an attack can be applied to the respective items (e.g., items 104A-n, 105A-n, 106A-n), assets (e.g., assets 134A-n), and suchlike. Method 1300 can return to step 1010 of FIG. 10.

At 1360, in response to a determination (e.g., by TARA tool 125, risk component 166) that NO, the determined risk is not acceptable, method 1300 can advance to step 1380, whereupon any of the attack scenario, cybersecurity control, damage scenario, software, ECU, network, items, one or more assets (e.g., assets 134), etc., can be reviewed to determine how the vehicle and one or more onboard systems/components/software can be further modified/protected/implemented to reduce any of the impact level of an attack, reduce/mitigate a feasibility of an attack, and/or reduce the risk value to an acceptable level. In view of the foregoing, a mitigation strategy can be applied/recommended (e.g., by TARA tool 125, iteration component 155, threat component 151, security component 160, damage component 165, risk component 166, processes 176A-n, etc.). The mitigation strategy can be applied. Method 1300 can return to 1370 to determine 1350 whether the currently being processed is the last threat scenario. In another embodiment, at 1380, as soon as the mitigation strategy is applied, the TARA process 410 can undergo a reiteration so as to assess the effect of the mitigation strategy across the items and assets.

As mentioned, various processes 176A-n can be configured to determine information, make predictions, etc., regarding implementation and operation of TARA system 120 and the respective components included therein for TARA of one or more designs of systems 101A-n for vehicles 102A-n. As previously mentioned, the processes 176A-n can include AI, ML and reasoning techniques/technologies that employ probabilistic and/or statistical-based analysis to prognose or infer an action that a user desires to be automatically performed. The various embodiments presented herein can utilize various ML-based schemes for carrying out various aspects thereof, e.g., generating/identifying/relating items 104A-n, 105A-n, 106A-n, assets 134A-n, generating threat scenarios 158A-n, generating damage scenarios 163A-n, generating cybersecurity controls 161A-n, determining risks 167A-n, generating recommendations 162A-n, and suchlike, which as mentioned, can be facilitated via an automatic classifier system and process.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In this particular embodiment, TARA tool 125, threat component 151, iteration component 155, security component 160, damage component 165, risk component 166, process component 170, and associated processes 176A-n include machine learning and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process for determining (a) items 104A-n, 105A-n, 106A-n, assets 134A-n, against which an attack 110A-n can be implemented, (b) one or more threat scenarios 158A-n, (c) one or more cybersecurity controls 161A-n, (d) one or more damage scenarios 163A-n, (e) one or more risks 167A-n, (f) acceptability of the risks 167A-n, (g) one or more mitigation strategies 162A-n, and suchlike, as previously mentioned herein, can be facilitated via an automatic classifier system and process.

A classifier is a function that maps an input attribute vector, x=(x1, x2, x3, x4, xn), to a class label class(x). The classifier can also output a confidence that the input belongs to a class, that is, ƒ(x)=confidence (class(x)). Such classification can employ a probabilistic and/or statistical-based analysis (e.g., factoring into the analysis utilities and costs) to prognose or infer an action that a user desires to be automatically performed (e.g., risk 167A-n of one or more elements/components of a system 101A-n is breached/compromised by an attack 110A-n).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, potential success of an attack 110A-n, and one or more recommendations 162A-n to adjust implementation/operation of items 104A-n, 105A-n, 106A-n, assets 134A-n, etc., in a system 101A-n, to reduce the likelihood of the attack 110A-n being successfully implemented against the system 101A-n, for example.

As described supra, inferences can be made, and operations performed, based on numerous pieces of information. For example, information/data regarding devices included in system 101A-n is combined with potential threats 158A-n, from which damage scenarios 163A-n are generated, risks 167A-n of damage determined, and mitigation strategies 162A-n derived, and suchlike, enabling a robust system 101A-n to be created with reduced/susceptibility to cyber-attacks 110A-n.

### Example Operating Environment and Scenarios

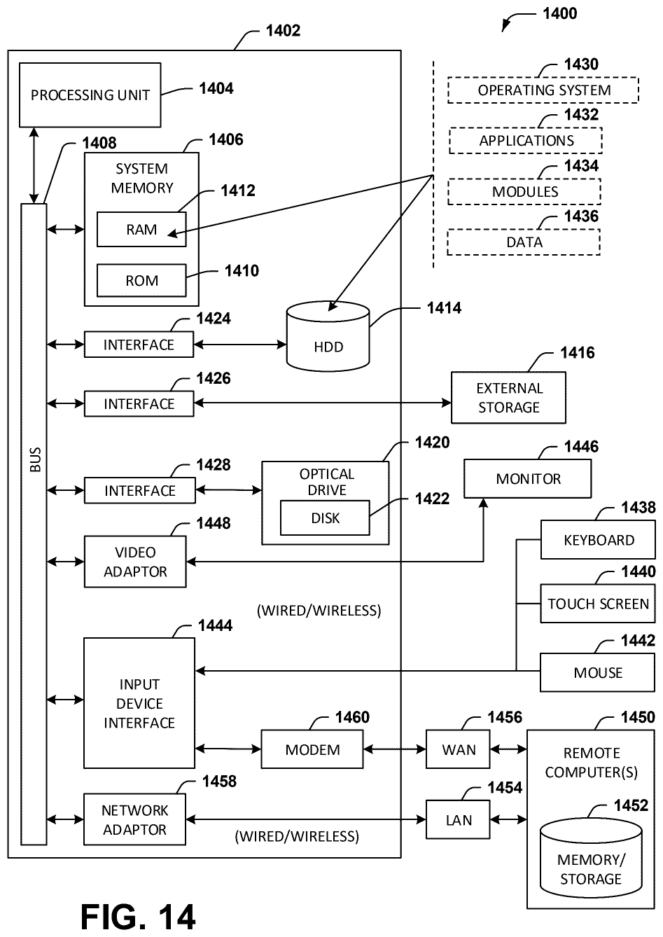

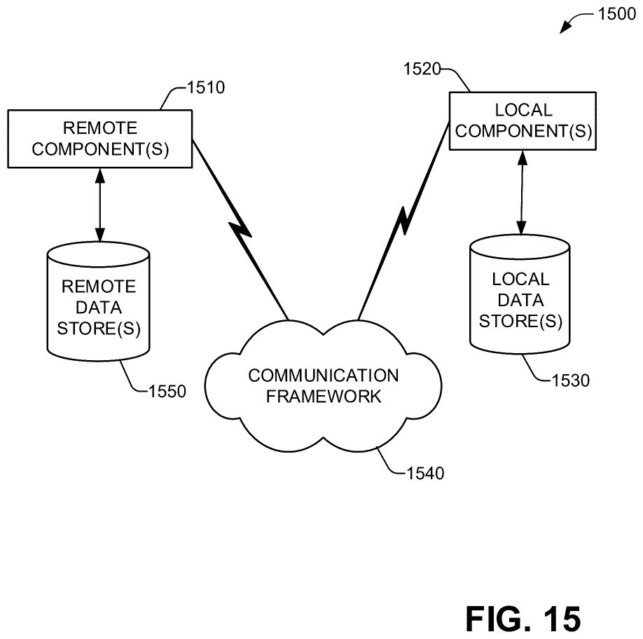

Turning next to FIGS. 14 and 15, a detailed description is provided of additional context for the one or more embodiments described herein with FIGS. 1-13.

In order to provide additional context for various embodiments described herein, FIG. 14 and the following discussion are intended to provide a brief, general description of a suitable computing environment 1400 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infra-red and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors and may include a cache memory. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid-state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can comprise a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infra-red (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 15, an illustrative cloud computing environment 1500 is depicted. FIG. 15 is a schematic block diagram of a computing environment 1500 with which the disclosed subject matter can interact. The system 1500 comprises one or more remote component(s) 1510. The remote component(s) 1510 can be hardware and/or software (e.g., threads, processes, computing devices). In some embodiments, remote component(s) 1510 can be a distributed computer system, connected to a local automatic scaling component and/or programs that use the resources of a distributed computer system, via communication framework 1540. Communication framework 1540 can comprise wired network devices, wireless network devices, mobile devices, wearable devices, radio access network devices, gateway devices, femtocell devices, servers, etc.

The system 1500 also comprises one or more local component(s) 1520. The local component(s) 1520 can be hardware and/or software (e.g., threads, processes, computing devices). In some embodiments, local component(s) 1520 can comprise an automatic scaling component and/or programs that communicate/use the remote resources 1510 and 1520, etc., connected to a remotely located distributed computing system via communication framework 1540.

One possible communication between a remote component(s) 1510 and a local component(s) 1520 can be in the form of a data packet adapted to be transmitted between two or more computer processes. Another possible communication between a remote component(s) 1510 and a local component(s) 1520 can be in the form of circuit-switched data adapted to be transmitted between two or more computer processes in radio time slots. The system 1500 comprises a communication framework 1540 that can be employed to facilitate communications between the remote component(s) 1510 and the local component(s) 1520, and can comprise an air interface, e.g., Uu interface of a UMTS network, via a long-term evolution (LTE) network, etc. Remote component(s) 1510 can be operably connected to one or more remote data store(s) 1550, such as a hard drive, solid state drive, SIM card, device memory, etc., that can be employed to store information on the remote component(s) 1510 side of communication framework 1540. Similarly, local component(s) 1520 can be operably connected to one or more local data store(s) 1530, that can be employed to store information on the local component(s) 1520 side of communication framework 1540.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses.
Clause 1. A system, comprising: a memory that stores computer executable components; and a processor that executes the computer executable components stored in the memory, wherein the computer executable components comprise: a threat analysis and risk assessment (TARA) tool configured to: determine a change in a first operating condition of an asset, wherein the asset represents an operational condition of an item, the change in operating condition results from a cyber-attack on the asset, and the change in operating condition generates a second operating condition of the asset; identify a first damage scenario pertaining to the second operating condition of the asset; and assess a result of the first damage scenario on operational condition of the item based on the second operating condition of the asset.
Clause 2. The system of any preceding clause, wherein the change in operating condition of the asset from a first operating condition to a second operating condition represents a change in operating condition of the asset in response to a simulation of the cyber-attack on the asset.
Clause 3. The system of any preceding clause, wherein the item is located on a vehicle.
Clause 4. The system of any preceding clause, wherein the vehicle is a software-defined vehicle.
Clause 5. The system of any preceding clause, wherein the item is one of a software application, an electronic control unit (ECU), or a network device.
Clause 6. The system of any preceding clause, wherein the asset is a software function implemented on the ECU.
Clause 7. The system of any preceding clause, wherein the TARA tool is further configured to: determine a first damage impact level for the first damage scenario, wherein the first damage impact level indicates a first magnitude of damage resulting from the second operating condition of the asset implemented on the item.
Clause 8. The system of any preceding clause, wherein the TARA tool is further configured to: determine whether a magnitude of the first damage impact level is acceptable; and in response to a determination that the magnitude of the first damage impact level is unacceptable, implement a third operating condition at the asset.
Clause 9. The system of any preceding clause, wherein the TARA tool is further configured to: determine a second magnitude of a second damage impact level resulting from the third operating condition; and in response to a determination that second damage impact level is acceptable, implementing the third operating condition on the item to mitigate an effect of the cyber-attack.
Clause 10. The system of any preceding clause, wherein the system is a centralized system, and is further configured to receive information from at least one of a product design database, an entity, a development team, or an organizational metamodel, and the information relates to the asset implemented a design of a computer system located on a vehicle.
Clause 11. The system of any preceding clause, wherein the first damage scenario comprises: a damage injured party attribute identifying an entity affected by the first damage scenario; a damage category attribute identifying a negative effect of the first damage scenario; or a damage condition attribute identifying a state when the first damage scenario occurred.
Clause 12. A computer-implemented method, comprising: identifying, by a device comprising a processor, an operational condition of an asset resulting from a cyber-attack implemented on the asset, wherein the asset represents a functionality of an item; determining, by the device, whether the operational condition of the asset deleteriously impacts operation of the item; and in response to a determination that the operation of the item is deleteriously impacted by the cyber-attack, indicating, by the device, that the asset is susceptible to the cyber-attack.
Clause 13. The computer-implemented method of any preceding clause, wherein the item is included in a computer system implemented on a software-defined vehicle.
Clause 14. The computer-implemented method of any preceding clause, wherein the item is one of a function type item, a hardware type item, or a network type item, wherein a function type item indicates the item is a software application, the hardware type item indicates the item is an electronic control unit (ECU), and the network type item indicates the item is one of a network device or network infrastructure.
Clause 15. The computer-implemented method of any preceding clause, wherein the asset is a function type asset configured to be implemented on the hardware type item.
Clause 16. The computer-implemented method of any preceding clause, wherein the device is located at a centralized system, and at least one of the asset or the item are retrieved from a product design database communicatively coupled to the centralized system.
Clause 17. A computer program product stored on a non-transitory computer-readable medium and comprising machine-executable instructions, wherein, in response to being executed, the machine-executable instructions cause computing equipment to perform operations, comprising: identifying an operational condition of an asset resulting from a cyber-attack implemented on the asset, wherein the asset represents a functionality of an item; determining whether the operational condition of the asset deleteriously impacts operation of the item; and in response to a determination that the operation of the item is deleteriously impacted by the cyber-attack, indicating the asset is susceptible to the cyber-attack.
Clause 18. The computer program product of any preceding clause, wherein the item is included in a computer system implemented on a software defined vehicle.
Clause 19. The computer program product of any preceding clause, the operations further comprising: determining a configuration of the asset, wherein the configuration is resistant to the cyber-attack; modifying the asset in accordance with the determined configuration; and implementing the modified asset on the item to mitigate an impact of the cyber-attack.
Clause 20. The computer program product of any preceding clause, wherein modification of the asset comprises recoding a software application, reconfiguring an electronic control unit, or reconfiguring a network architecture.

In various cases, any suitable combination of clauses 1-11 can be implemented.

In various cases, any suitable combination of clauses 12-16 can be implemented.

In various cases, any suitable combination of clauses 17-20 can be implemented.

What is claimed is:

1. A system, comprising:
a memory that stores computer executable components; and
a processor that executes the computer executable components stored in the memory, wherein the computer executable components comprise:
a threat analysis and risk assessment (TARA) tool configured to:
determine a change in a first operating condition of an asset, wherein the asset represents an operational condition of an item, the change in operating condition results from a cyber-attack on the asset, and the change in operating condition generates a second operating condition of the asset;
identify a first damage scenario pertaining to the second operating condition of the asset; and
assess a result of the first damage scenario on operational condition of the item based on the second operating condition of the asset.

2. The system of claim 1, wherein the change in operating condition of the asset from a first operating condition to a second operating condition represents a change in operating condition of the asset in response to a simulation of the cyber-attack on the asset.

3. The system of claim 1, wherein the item is located on a vehicle.

4. The system of claim 3, wherein the vehicle is a software-defined vehicle.

5. The system of claim 1, wherein the item is one of a software application, an electronic control unit (ECU), or a network device.

6. The system of claim 5, wherein the asset is a software function implemented on the ECU.

7. The system of claim 1, wherein the TARA tool is further configured to:
determine a first damage impact level for the first damage scenario, wherein the first damage impact level indicates a first magnitude of damage resulting from the second operating condition of the asset implemented on the item.

8. The system of claim 7, wherein the TARA tool is further configured to:
determine whether a magnitude of the first damage impact level is acceptable; and
in response to a determination that the magnitude of the first damage impact level is unacceptable, implement a third operating condition at the asset.

9. The system of claim 8, wherein the TARA tool is further configured to:
determine a second magnitude of a second damage impact level resulting from the third operating condition; and
in response to a determination that second damage impact level is acceptable, implementing the third operating condition on the item to mitigate an effect of the cyber-attack.

10. The system of claim 1, wherein the system is a centralized system, and is further configured to receive information from at least one of a product design database, an entity, a development team, or an organizational metamodel, and the information relates to the asset implemented a design of a computer system located on a vehicle.

11. The system of claim 1, wherein the first damage scenario comprises:
a damage injured party attribute identifying an entity affected by the first damage scenario;
a damage category attribute identifying a negative effect of the first damage scenario; or
a damage condition attribute identifying a state when the first damage scenario occurred.

12. A computer-implemented method, comprising:
identifying, by a device comprising a processor, an operational condition of an asset resulting from a cyber-attack implemented on the asset, wherein the asset represents a functionality of an item;
determining, by the device, whether the operational condition of the asset deleteriously impacts operation of the item; and
in response to a determination that the operation of the item is deleteriously impacted by the cyber-attack, indicating, by the device, that the asset is susceptible to the cyber-attack.

13. The computer-implemented method of claim 12, wherein the item is included in a computer system implemented on a software-defined vehicle.

14. The computer-implemented method of claim 12, wherein the item is one of a function type item, a hardware type item, or a network type item, wherein a function type item indicates the item is a software application, the hardware type item indicates the item is an electronic control unit (ECU), and the network type item indicates the item is one of a network device or network infrastructure.

15. The computer-implemented method of claim 14, wherein the asset is a function type asset configured to be implemented on the hardware type item.

16. The computer-implemented method of claim 12, wherein the device is located at a centralized system, and at least one of the asset or the item are retrieved from a product design database communicatively coupled to the centralized system.

17. A computer program product stored on a non-transitory computer-readable medium and comprising machine-executable instructions, wherein, in response to being executed, the machine-executable instructions cause computing equipment to perform operations, comprising:
identifying an operational condition of an asset resulting from a cyber-attack implemented on the asset, wherein the asset represents a functionality of an item;
determining whether the operational condition of the asset deleteriously impacts operation of the item; and
in response to a determination that the operation of the item is deleteriously impacted by the cyber-attack, indicating the asset is susceptible to the cyber-attack.

18. The computer program product according to claim 17, wherein the item is included in a computer system implemented on a software defined vehicle.

19. The computer program product according to claim 17, the operations further comprising:
determining a configuration of the asset, wherein the configuration is resistant to the cyber-attack;
modifying the asset in accordance with the determined configuration; and
implementing the modified asset on the item to mitigate an impact of the cyber-attack.

20. The computer program product according to claim 19, wherein modification of the asset comprises recoding a software application, reconfiguring an electronic control unit, or reconfiguring a network architecture.
